(19) United States
(12) Patent Application Publication
(10) Pub. No.: US 2025/0354725 A1
(43) Pub. Date: Nov. 20, 2025

(54) HEAT RETENTION SYSTEM AND HEAT RETENTION DEVICE

(71) Applicant: Tatsuya SHINTANI, Sakurai-shi (JP)

(72) Inventor: Tatsuya SHINTANI, Sakurai-shi (JP)

(21) Appl. No.: 17/418,266

(22) PCT Filed: Dec. 25, 2019
(86) PCT No.: PCT/JP2019/051026

§ 371 Date: Mar. 22, 2022

(30) Foreign Application Priority Data
Dec. 25, 2018 (JP) 2018-248959
Dec. 25, 2018 (JP) 2018-248960
Mar. 1, 2019 (JP) 2019-055585

(51) Int. Cl. F24T 10/30; A01K 61/10

(52) U.S. Cl. CPC F24T 10/30; A01K 61/10

(57) ABSTRACT

The heat retention system (1) is equipped with a storage section (10), a passage section (30), and a guide section (40). The passage section (30) constitutes a passage for substances as a medium for transporting heat. The storage section (10) stores the substance. The guide section (40) connects the storage section (10) to the passage section (30) and guides the substance from the storage section (10) to the passage section (30). The passage section (30) is located in the housing space (330) that houses the object. A first housing section (20) that houses the object is further included. The first housing section (20) is disposed in the housing space (330). The substance is a liquid (LQ). The storage section (10) is located in the ground (G2). The first storage section (20) is located in the containment space (330). The guide section (40) guides the liquid (LQ) from the storage section (10) to the passage section (30). The passage section (30) is disposed outside the first storage section (20).

### TECHNICAL FIELD

The present invention relates to a heat retention system and a heat retention device.

### BACKGROUND TECHNOLOGY

The cultivation facility described in Patent Document 1 is equipped with a cultivation room, a light path, a harvesting robot, and an air conditioning system. The cultivation room is used to grow plants. The growing room is located underground and consists of a space with limited sunlight. A light path connects the growing room to the ground. The light path leads sunlight into the growing room. The harvesting robot is placed in the growing room. The air conditioning system controls the temperature and humidity in the growing room.

### PRIOR ART DOCUMENT

### Patent document

[Patent Document 1] Patent Publication No. 2016-2058

### SUMMARY OF THE INVENTION

### Problem to be Solved by the Invention

The purpose of this invention is to provide a novel heat retention system for keeping objects warm.

### Means to Solve the Problem

According to an aspect of the present invention, a heat retention system has a passage section, a storage section, and a guide section. The passage section constitutes a passage for a substance as a medium for transporting heat. The storage section stores the substance. The guide section connects the storage section and the passage section to guide the substance from the storage section to the passage section. The passageway section is located in a housing space that houses an object.

According to another aspect of the present invention, the heat retention system further includes a first housing section. The first housing section accommodates an object. The first housing section is disposed in a housing space. The passageway section is disposed outside the first housing section.

According to another aspect of the invention, said storage section is located underground. The first storage section houses an organism. Said substance is a liquid. The guide section guides the liquid from the storage section to the passage section.

According to another aspect of the present invention, the heat retention system is further provided with a second housing section. The second housing section accommodates the first housing section. The passage section is disposed along an outer surface of the second housing section.

According to another aspect of the invention, the second housing section of the heat retention system is located underground.

According to another aspect of the present invention, the heat retention system is further equipped with a moving part. The moving section moves the first housing section.

According to another aspect of the invention, said passage part of the heat retention system transmits light.

According to another aspect of the present invention, the heat retention system is further provided with a plurality of said passage sections. The plurality of passage sections are disposed outside of the first housing section. Each of said plurality of passage sections includes a plurality of passage bodies. The plurality of passage bodies are connected in series.

According to another aspect of the invention, the heat retention system includes a plurality of said storage sections. The plurality of storage sections have different depths from the ground surface. The heat retention system further includes a switching section. The switching section switches the source of the liquid that is guided toward the passage section. The switching section switches the source of supply from the storage section that is set as the source of supply among the plurality of storage sections to another storage section.

According to another aspect of the invention, the heat retention system is further equipped with a working room. The working room is carried by the first housing unit first housing unit. The working room is shut off from the outside.

According to an aspect of the present invention, a heat retention device is provided with a passage section and a guide section. The passage section comprises a passage for heat-mediated substances. The guiding section guides the substance stored in the storage section from the storage section to the passage section. The passageway section is located in a housing space that houses an object.

According to another aspect of the present invention, the heat retention device further includes a first housing section. The first housing section accommodates an object. The first housing section is disposed in a housing space. The passage section is disposed outside the first housing section.

According to another aspect of the invention, said storage section is located underground. The first storage section houses an organism. Said substance is a liquid. The guide section guides the liquid from the storage section to the passage section.

According to an aspect of the invention, the heat retention system has a first housing section, a second housing section, a thermal radiation member, a light guide section, and an introduction section. The first housing section accommodates an object. The second housing section accommodates the first housing section. The thermal radiation member emits light by heating. The light guide section guides the light emitted by the thermal radiation member. The introduction section introduces carbon dioxide into the second housing section. The second housing section has a light emitting section that emits light. The light guiding section leads the light emitted by the thermal radiation member to the light emitting section. The light emitting part fires the light guided by the light guide.

According to another aspect of the invention, the first housing section grows organisms. The second housing section is located in the ground.

According to an aspect of the present invention, a heat retention system has a plurality of storage sections, a first housing section, a guiding section, and a switching section. The plurality of storage sections differ from each other in the temperature of the stored material. The first storage section stores an object. The guiding section connects the storage section to the first accommodation section and guides the substance from the storage section to the first accommodation section. The switching section switches the source of said substance to be guided to said first accommodation section. The switching section switches the source of supply from the storage section set as the source of supply among the plurality of storage sections to another storage section.

According to another aspect of the invention, each of the plurality of reservoirs has a different depth from the ground surface. The first storage section houses an organism. Said substance is a liquid. The guiding section guides the liquid from the storage section to the passage section. The switching section switches the source of said liquid that is guided to said first housing section.

According to another aspect of the invention, the shape of said first housing section is annular. The size of the first housing section is in accordance with the size of the organism.

### Effect of the Invention

According to the heat retention system and the heat retention device, the cost of adjusting the temperature can be controlled.

### BRIEF DESCRIPTION OF THE DRAWING

FIG. 1 shows a schematic diagram of the heat retention system of Embodiment 1.

FIG. 2: Another schematic diagram of the heat retention system for Embodiment 1.

FIG. 3: Schematic diagram of the storage section for Form 1.

FIG. 4: Schematic diagram of the cylinder section in an enlarged view.

FIG. 5: Diagram of the plurality of cylindrical sections for Embodiment 1.

FIG. 6: Schematic cross-sectional view of the cylindrical section of Embodiment 1.

FIG. 7: Schematic cross-sectional view of the cylinder section viewed from a different side than FIG. 6.

FIG. 8 shows the workroom of the heat retention system.

FIG. 9: Schematic diagram of the heat retention system of Embodiment 2 of the invention.

FIG. 10: The housing section of the heat retention system for the invention of Form 3.

FIG. 11: The working room of the heat retention system for the invention of Form 3.

FIG. 12: Schematic diagram of the heat retention system for Embodiment 4 of the invention.

FIG. 13: The housing section of the heat retention system according to Form 4.

FIG. 14: A heat retention system with a plurality of housing sections according to Embodiment 4.

FIG. 15: Schematic diagram of the heat retention system for Embodiment 5 of the invention.

FIG. 16: Enlarged view of the growing section of the heat retention system for Embodiment 5.

FIG. 17: The second piping of the heat insulation system according to Embodiment 5.

FIG. 18: Schematic diagram of the heat retention system of Embodiment 6 of the present invention.

### FORM FOR IMPLEMENTING THE INVENTION

An embodiment of the present invention will be described below with reference to the drawings. In the figures, the same reference signs are used for the same or equivalent parts, and the explanation is not repeated.

### [Form 1]

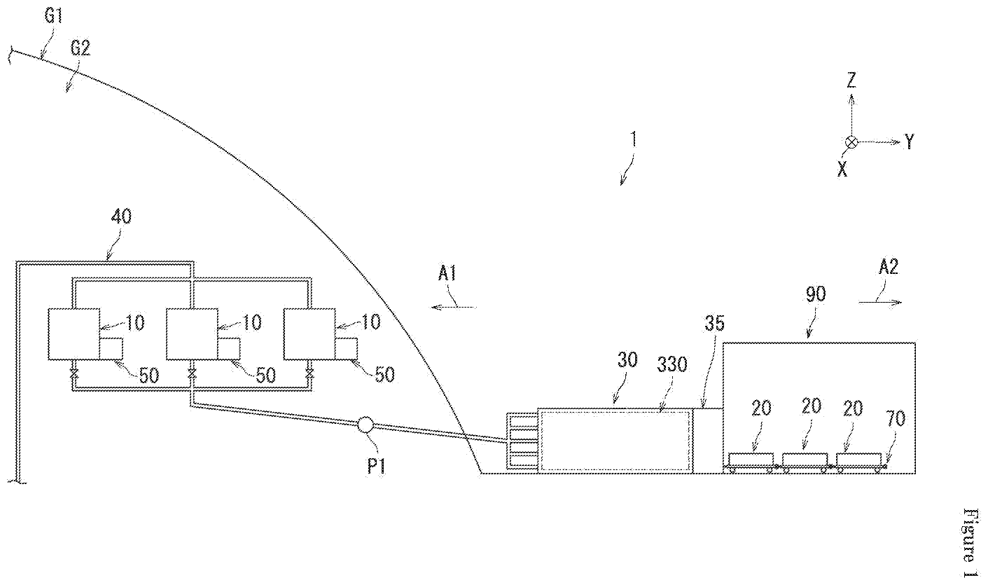

Referring to FIGS. 1 through 4, the heat retention system 1 in accordance with an embodiment of the present invention will be described. FIG. 1 is a schematic diagram of the heat retention system 1 in accordance with an embodiment of the present invention.

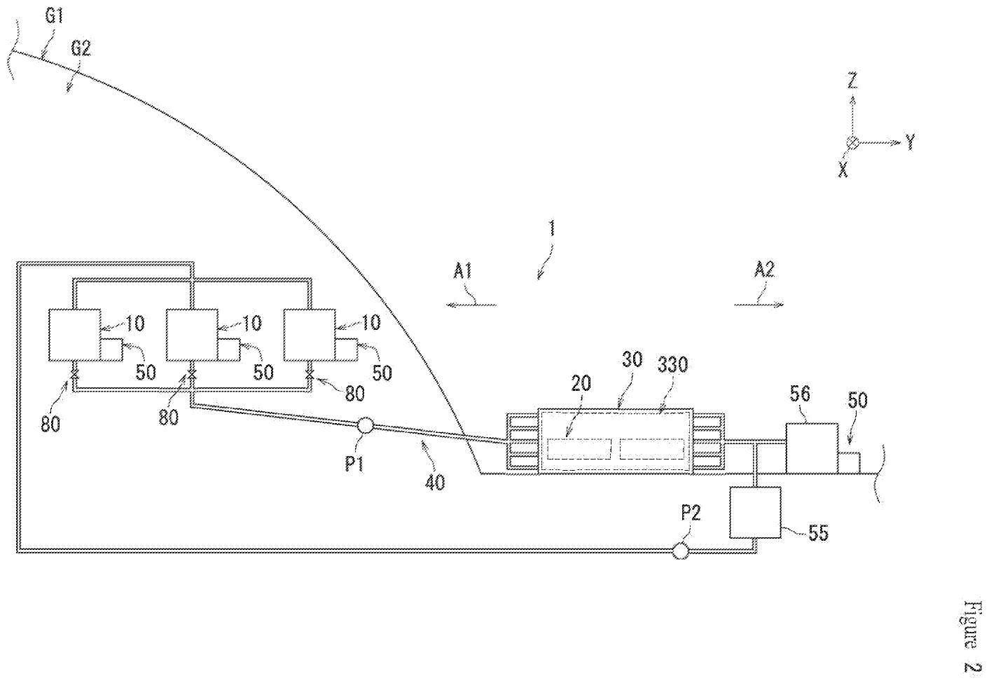

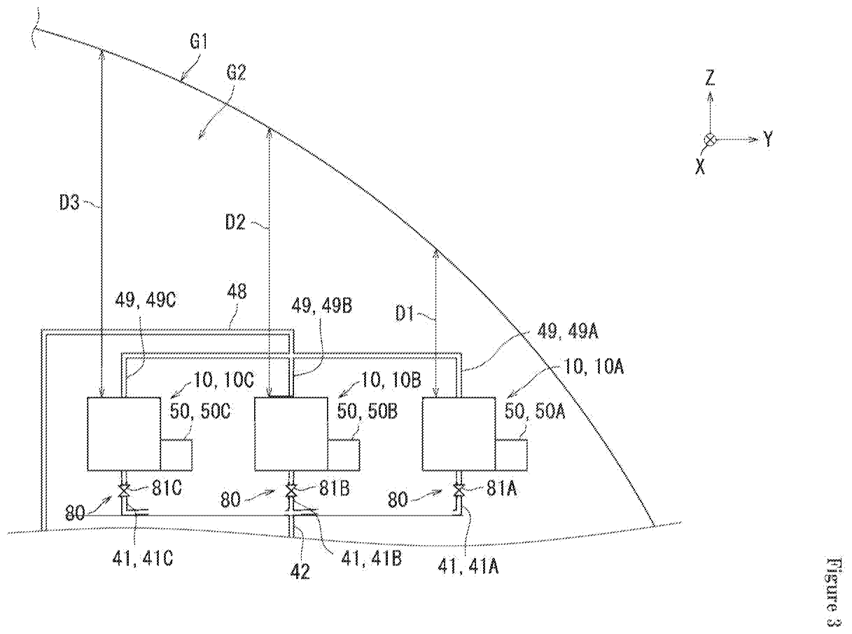

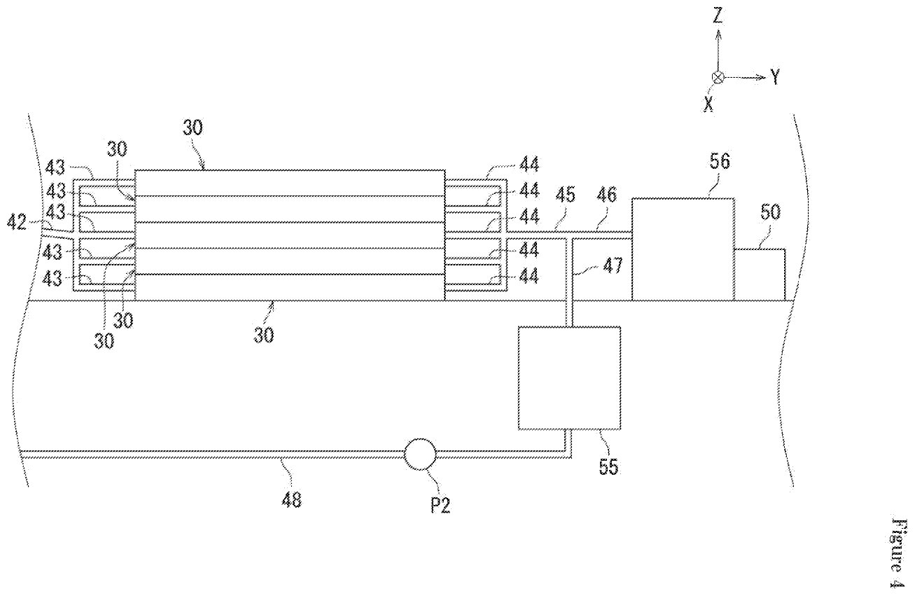

FIG. 2 is another schematic diagram showing the heat retention system 1 in accordance with an embodiment of the present invention. In FIG. 2, the workroom 90 is excluded in order to explain the heat retention system 1 in detail. FIG. 3 is a schematic diagram showing the storage section 10 in an enlarged view. FIG. 4 is a schematic diagram showing the cylinder section 30 in an enlarged view. As shown in FIGS. 1 to 4, the heat retention system 1 is placed, for example, on the slope of a mountain, or a hill. The heat retention system 1 may also be a biological growth system.

As shown in FIG. 1 and FIG. 2, the heat retention system 1 has a storage section 10, a growing section 20, a tube section 30, a guiding section 40, a temperature control section 50, a storage section 55, a storage section 56, a passage 35, a working room 90, a first pump P1, and a second pump P2.

As shown in FIGS. 1 through 3, the storage section 10 stores substances as a medium for transporting heat. The substance is a material that is capable of storing heat. The substance is a material capable of storing heat, for example, a fluid, a liquid, a granular material, and a plasma. For example, the storage section 10 stores a liquid (hereinafter, the liquid may be referred to as liquid LQ). The liquid LQ is, for example, water. For example, the liquid LQ is water. For example, hot spring water, groundwater, or rainwater is stored in the storage section 10. The liquid LQ may be seawater. As shown in FIG. 1, the storage section 10 is located in the ground G2. The storage section 10 may also be located above ground.

As shown in FIG. 3, the storage section 10 is located in the ground G2. In other words, the storage section 10 is located at a predetermined depth D from the ground surface G1. The predetermined depth D is, for example, a depth of “3 m” or more from the ground surface G1. When the storage section 10 is located in the ground G2, the temperature of the liquid LQ stored in the storage section 10 is maintained at a temperature corresponding to the depth from the ground surface G1. The temperature of the liquid LQ stored in the reservoir 10 is maintained at a temperature that depends on the depth from the ground surface G1. The temperature that depends on the depth from the ground surface G1 is described in the following. Ground temperature data in Japan (http://www.ai.ga.a.u-tokyo.ac.jp/mizo/research/soildb/ground_T_db.html)

The predetermined depth D may be changed depending on the latitude. In this embodiment, for example, it is preferable that the storage section 10 is located at a depth D at which the temperature of the liquid LQ stored in the storage section 10 is “about 15 degrees or more”.

As shown in FIG. 1, the growing section 20 houses an object. The object includes, for example, at least one of an inorganic substance or an organic substance. The inorganic material is, for example, water. The organic material is, for example, biological LF. The growing section 20 corresponds to an example of the “first housing section. For example, the growing section 20 grows the organism LF. The organism LF is, for example, a plant. The plant is, for example, a vegetable or a fruit that can be grown at about 15° C. to about 17° C. The vegetable is, for example, lettuce. A fruit is, for example, a strawberry. An organism LF is, for example, a fish. A fish is, for example, a fish that can be grown at about 15° C. to about 17° C. An example of a fish is a rainbow trout. The organism LF is an insect. The insect is, for example, a locust. The growing section 20 will be described later.

The cylindrical section 30 constitutes a passage for liquid LQ. The cylindrical section 30 corresponds to an example of a “passage part. In other words, the cylindrical portion 30 constitutes a flow path of liquid LQ. The cylinder section 30 is connected to the storage section 10 by the guide section 40. There may be one or more cylindrical sections 30. The cylindrical section 30 may be annular. When the cylinder is annular, the growing section 20 is placed on the inner edge of the cylinder.

As shown in FIG. 4, the cylindrical section 30 has a first end and a second end. The first end portion is the end portion located on the first direction A1 side as shown in FIG. 2. The first direction A1 is the direction from the plurality of cylinder sections 30 to the storage section 10. The second end is the end located on the second direction A2 side, as shown in FIG. 2. The second direction A2 is a direction from the plurality of cylindrical sections 30 to the work chamber 90 side. Each of the plurality of cylindrical section 30 is hollow inside. The interior of the cylindrical sections constitutes a flow path through which liquid LQ flows from the first end portion to the second end portion.

As shown in FIGS. 1 through 4, the guide section 40 connects the storage section 10 to the cylinder section 30. The guide section 40 guides the liquid LQ from the storage section 10 to the cylinder section 30. The guide section 40 is a flow path for liquid LQ. The guide section 40 is cylindrical in shape. For example, the guide section 40 is a cylindrical pipe. The guiding section 40 may be inclined so that the liquid LQ flows from the storage section 10 to the cylindrical section 30.

The temperature control section 50 adjusts the temperature of the liquid LQ. Specifically, the temperature control unit 50 heats the liquid LQ stored in the storage section 10 to adjust the temperature of the liquid LQ. Also, the temperature control unit 50 cools the liquid LQ stored in the storage section 10 to adjust the temperature of the liquid L.Q. The temperature of the liquid LQ stored in the storage section 10 is maintained at a temperature corresponding to the depth of the storage section 10 from the ground surface G1. Therefore, when heating the liquid LQ to the desired temperature, the liquid LQ can be heated based on the temperature corresponding to the depth from the ground surface G1. Also, when cooling the liquid LQ to the desired temperature, the liquid LQ can be cooled based on the temperature corresponding to the depth from the surface G1. As a result, it becomes easier to achieve the desired temperature.

The temperature control section 50 heats the liquid LQ stored in the storage section 56 to adjust the temperature of the liquid LQ. The temperature control unit 50 also cools the liquid LQ stored in the storage section 56 to adjust the temperature of the liquid LQ.

The storage section 55 stores the liquid LQ flowing out of the cylinder sections 30. The storage section 55 temporarily stores the liquid LQ flowing out from the plurality of cylinder sections 30.

The storage section 56 stores the liquid LQ flowing out from the cylinder sections 30. The storage section 56 temporarily stores the liquid LQ flowing out from the plurality of cylinder sections 30. The storage section 56 is arranged to keep the amount of liquid LQ transferred to the storage section 10 constant.

The passage 35 connects the growing section 20 to the working chamber 90. The passage 35 connects the space enclosed by the tube 30 to the working chamber 90. The interior space of the working chamber is closed off from the exterior of the working chamber.

The working room 90 is where the growing section 20 is transported. In the workroom 90, a worker places water and soil in the growing section 20. In the workroom 90, the operator places the organism LF in the growing area 20. In the workroom 90, the operator harvests the organisms LF grown in the growing section 20.

The first pump P1 transfers the liquid I.Q. Specifically, the first pump P1 transfers the liquid LQ that has flowed out of the storage section 10 toward the plurality of cylinder sections 30. The first pump P1 is attached to the guide section 40. Specifically, the first pump P1 is attached to the guiding section 40 that connects the storage section 10 to the plurality of cylinderl sections 30. By driving the first pump P1, the liquid LQ in the storage section 10 is transferred through the guide section 40 to the plurality of cylinder sections 30.

The second pump P′2 transfers the liquid LQ. Specifically, the second pump P2 transfers the liquid LQ that flows out of the storage section 55 toward the storage section 10. The second pump P2 is attached to the guide section 40. Specifically, the second pump P2 is attached to the guide section 40 that connects the storage section 55 to the storage section 10. By driving the second pump P2, the liquid LQ in the storage section 55 is transferred to the storage section 10 through the guide section 40. The liquid LQ is circulated by the first pump P1 and the second pump P2.

Next, referring to FIGS. 1-3, the storage section 10, the guiding section 40, and the temperature control section 50 will be explained in more detail.

As shown in FIG. 3, the storage section 10 includes a first storage section 10A, a second storage section 10B, and a third storage section 10C. The first storage section 10A is located in the ground G2. The position of the first storage section 10A in the ground G2 is the position where the depth from the ground surface G1 is the depth D1. The depth D1 is, for example, a depth of “3 m” from the ground surface G1.

The second storage section 10B is located in the ground G2. The position of the second storage section 10B in the ground G2 is the position where the depth from the ground surface G1 is the depth D2. The depth D2 is deeper than the depth D1. For example, the depth D2 is the position where the depth from the ground surface G1 is “5 m”. The temperature of the liquid LQ stored in the second storage section 10B is different from the temperature of the liquid LQ stored in the first storage section 10A. For example, the temperature of the liquid LQ stored in the second storage section 10B during the summer season is lower than the temperature of the liquid LQ stored in the first storage section 10A. The summer season is, for example, a time when the average daily temperature is 25 degrees Celsius or higher. For example, in winter, the temperature of the liquid LQ stored in the second storage section 10B is higher than that of the liquid LQ stored in the first storage section 10A. The winter season is, for example, a time when the average daily temperature is below 10 degrees Celsius.

The third storage section 10C is located in the ground G2. The position of the third storage section 10C in the ground G2 is the position where the depth from the ground surface G1 is the depth D3. The depth D3 is deeper than the depth D2. The depth D3 is, for example, the position where the depth from the ground surface G1 is “10 m”. The temperature of the liquid LQ stored in the third storage section 10C is different from the temperature of the liquid LQ stored in the first storage section 10A and the temperature of the liquid LQ stored in the second storage section 10B. For example, the temperature of the liquid LQ stored in the third storage section 10C in summer is lower than the temperature of the liquid LQ stored in the first storage section 10A and the temperature of the liquid LQ stored in the second storage section 10B. Also, for example, the temperature of the liquid LQ stored in the third storage section 10C in winter is higher than the temperature of the liquid LQ stored in the first storage section 10A and the temperature of the liquid LQ stored in the second storage section 10B.

As shown in FIGS. 2 through 4, the guide section 40 has a first guide section 41, a second guide section 42, a third guide section 43, a fourth guide section 44, a fifth guide section 45, a sixth guide section 46, a seventh guide section 47, an eighth guide section 48, and a ninth guide section 49.

The first guiding section 41 guides the liquid LQ stored in the storage section 10 from the storage section 10 to the second guiding section 42. The first guiding section 41 is connected to the storage section 10 and the second guiding section 42. Specifically, one end of the first guiding section 41 is connected to the storage section 10. The other end of the first guide section 41 is connected to the second guide section 42. The first guiding section 41 has a first guiding section 41A, a first guiding section 41B, and a first guiding section 41C.

The first guide section 41A guides the liquid LQ stored in the first storage section 10A from the first storage section 10A to the second guide section 42. One end of the first guiding section 41A is connected to the first storage section 10A. The other end of the first guiding section 41A is connected to the second guiding section 42.

The first guide section 41B guides the liquid LQ stored in the second storage section 10B from the second storage section 10B to the second guide section 42. One end of the first guiding section 41B is connected to the second storage section 10B. The other end of the first guide section 41B is connected to the second guide section 42.

The first guiding section 41C guides the liquid LQ stored in the third storage section 10C from the third storage section 10C to the second guiding section 42. One end of the first guiding section 41C is connected to the third storage section 10C. The other end of the first guiding section 41C is connected to the second guiding section 42.

The second guiding section 42 guides the liquid LQ flowing in from the first guiding section 41 to the third guiding section 43. The second guiding section 42 is connected to the first guiding section 41 and the third guiding section 43. Specifically, one end of the second guiding section 42 is connected to the first guiding section 41. The other end of the second guide section 42 is connected to the third guide section 43.

The third guiding section 43 guides the liquid LQ flowing in from the second guiding section 42 to the plurality of cylindrical sections 30. The third guiding section 43 is connected to the second guiding section 42 and the cylindrical sections 30. Specifically, one end of the third guiding section 43 is connected to the second guiding section 42. The other end of the third guiding section 43 is connected to the plurality of cylindrical sections 30.

The fourth guiding section 44 guides the liquid LQ flowing in from the plurality of cylindrical sections 30 to the fifth guiding section 45. The fourth guiding section 44 is connected to the plurality of cylindrical sections 30 and the fifth guiding section 45. Specifically, one end of the fourth guiding section 44 is connected to the plurality of cylindrical sections 30. The other end of the fourth guide section 44 is connected to the fifth guide section 45.

The fifth guide section 45 guides the liquid LQ flowing in from the fourth guide section 44 to the sixth guide section 46 and the seventh guide section 47. The fifth guide section 45 is connected to the fourth guide section 44 and the sixth guide section 46. The fifth guiding section 45 is connected to the fourth guiding section 44 and the seventh guiding section 47. Specifically, one end of the fifth guide section 45 is connected to the fourth guide section 44. The other end of the fifth guide section 45 is connected to the sixth guide section 46 and the seventh guide section 47.

The sixth guiding section 46 guides the liquid LQ flowing in from the fifth guiding section 45 to the storage section 56. The sixth guide section 46 is connected to the fifth guide section 45 and the storage section 56. Specifically, one end of the sixth guide section 46 is connected to the fifth guide section 45. The other end of the sixth guide section 46 is connected to the storage section 56.

The seventh guiding section 47 guides the liquid LQ flowing in from the fifth guiding section 45 to the storage section 55. The seventh guiding section 47 is connected to the fifth guiding section 45 and the storage section 55. Specifically, one end of the seventh guide section 47 is connected to the fifth guide section 45. The other end of the seventh guide section 47 is connected to the storage section 55.

The eighth guiding section 48 guides the liquid LQ flowing in from the storage section 55 to the ninth guiding section 49. The eighth guiding section 48 is connected to the storage section 55 and the ninth guiding section 49. Specifically, one end of the eighth guide section 48 is connected to the storage section 55. The other end of the eighth guide section 48 is connected to the ninth guide section 49.

The ninth guiding section 49 guides the liquid LQ flowing in from the eighth guiding section 48 to the storage section 10. The ninth guiding section 49 is connected to the eighth guiding section 48 and the storage section 10. Specifically, one end of the ninth guiding section 49 is connected to the eighth guiding section 48. The other end of the ninth guiding section 49 is connected to the storage section 10. The ninth guiding section 19 has a ninth guiding section 49A, a ninth guiding section 49B, and a ninth guiding section 49C.

The ninth guiding section 49A guides the liquid LQ flowing in from the eighth guiding section 48 to the first storage section 10A. One end of the ninth guiding section 49A is connected to the eighth guiding section 48. The other end of the ninth guiding section 49A is connected to the first storage section 10A.

The ninth guiding section 49B guides the liquid LQ flowing in from the eighth guiding section 48 to the second storage section 10B. One end of the ninth guiding section 49B is connected to the eighth guiding section 48. The other end of the ninth guiding section 49B is connected to the second storage section 10B.

The ninth guiding section 49C guides the liquid LQ flowing in from the eighth guiding section 48 to the third storage section 10C. One end of the ninth guiding section 49C is connected to the eighth guiding section 48. The other end of the ninth guiding section 49C is connected to the third storage section 10C.

As shown in FIG. 2 and FIG. 3, the temperature adjusting section 50 has a first temperature control section 50A, a second temperature adjusting section 50B, and a third temperature control section 50C.

The first temperature adjusting section 50A adjusts the temperature of the liquid LQ stored in the first storage section 10A. Specifically, the first temperature control section 50A heats the liquid LQ stored in the first storage section 10A to adjust the temperature of the liquid I.Q. Also, the first temperature control section 50A cools the liquid LQ stored in the first storage section 10A to adjust the temperature of the liquid LQ.

The second temperature adjusting section 50B adjusts the temperature of the liquid LQ stored in the second storage section 10B. Specifically, the second temperature adjusting section 50B heats the liquid LQ stored in the second storage section 10B to adjust the temperature of the liquid LQ. Also, the second temperature control section 50B cools the liquid LQ stored in the second storage section 10B to adjust the temperature of the liquid LQ.

The third temperature adjusting section 50C adjusts the temperature of the liquid LQ stored in the third storage section 10C. Specifically, the third temperature adjusting section 50C heats the liquid LQ stored in the third storage section 10C to adjust the temperature of the liquid LQ. Also, the third temperature control section 50C cools the liquid LQ stored in the third storage section 10C to adjust the temperature of the liquid LQ.

The heat retention system 1 of this embodiment has a temperature adjusting section 50, but this is not limited to the temperature adjusting section 50. For example, the heat retention system 1 does not have to have a temperature adjusting section 50.

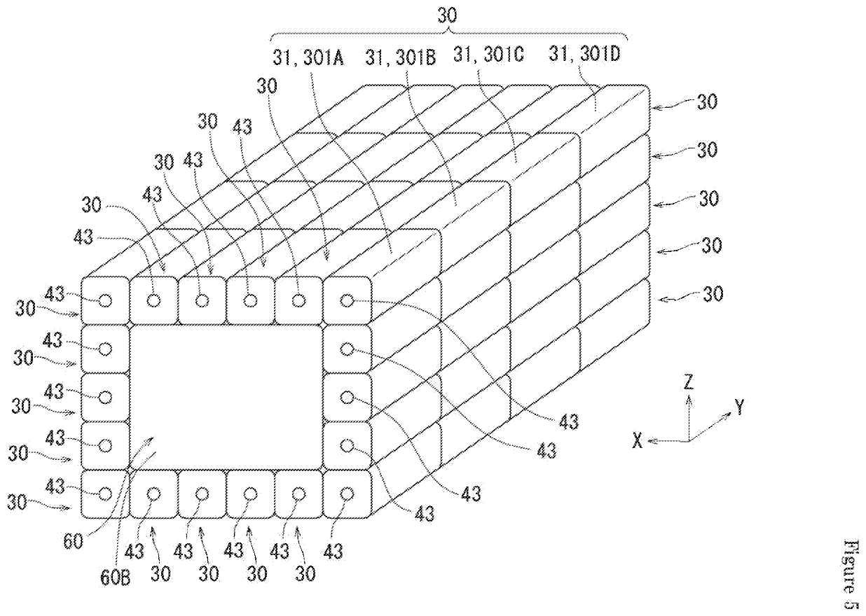

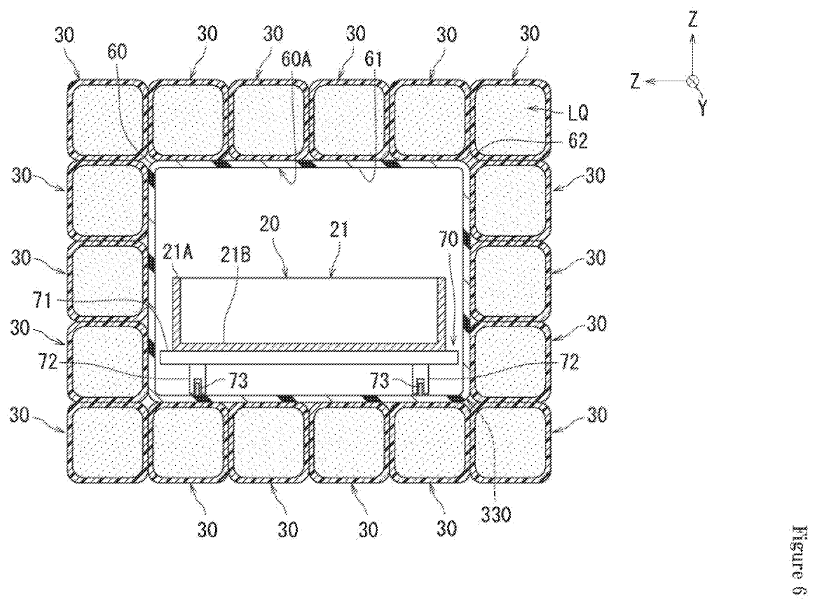

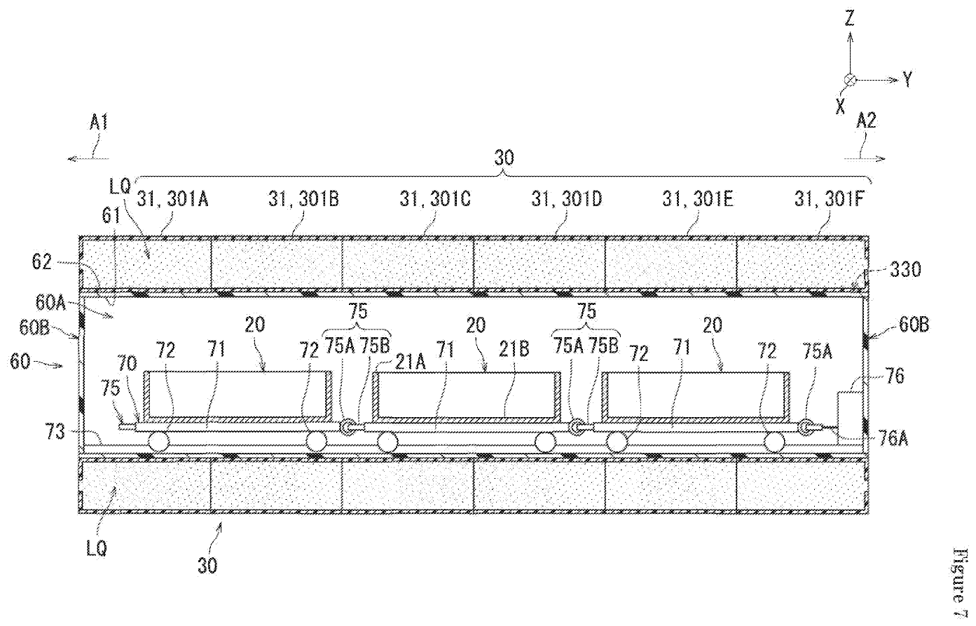

Next, referring to FIGS. 1 through 7, the cylindrical sections 30 of the present embodiment will be described in further detail. FIG. 5 shows a diagram of the plurality of cylinder sections 30 pertaining to the present embodiment. In FIG. 5, the guide section 10 is omitted to facilitate the understanding of the invention. FIG. 6 schematically shows a cross-section of the cylindrical sections 30 of the present embodiment. FIG. 7 schematically shows a cross-section of the cylindrical section 30 viewed from a side different from FIG. 6. As shown in FIG. 1, a storage space 330 is formed inside the cylindrical portion 30. An object is accommodated in the storage space 330. In other words, the cylindrical section 30 is placed in the storage space 330. Specifically, the cylindrical part 30 is placed on the outside of the storage space 330. The cylindrical section 30 may also be disposed inside the storage space 330. The growing section 20 may be disposed in the storage section 330. In the storage section 330, the storage section 60, to be described later, may be disposed, and the growing section 20 may be accommodated in the storage section 60.

As shown in FIG. 6, a plurality of cylinder sections 30 are located outside the growing section 20. In other words, the cylindrical sections 30 guided by liquid LQ are located outside the growing section 20. As a result, the temperature of the growing section 20 can be easily maintained.

When the liquid LQ is guided from the storage section 10 located in the ground G2, the liquid LQ maintained at a predetermined temperature is guided from the storage section 10 to the plurality of cylindrical sections 30, and the liquid LQ flows into the plurality of cylindrical sections 30. Furthermore, the liquid LQ maintained at the predetermined temperature passes through the plurality of cylindrical sections 30. Therefore, the temperature of the growing section 20 side can be changed by using the liquid LQ of a predetermined temperature. Therefore, the temperature of the growing section 20 can be adjusted without using a heating device and a cooling device. As a result, the cost of adjusting the temperature of the growing section 20 can be reduced.

For example, in a conventional cultivation facility, the air conditioning system cannot control the cost of adjusting the temperature of the growing section such as the cultivation room. Therefore, the cost of adjusting the temperature of the growing section could not be controlled. On the other hand, in the heat retention system 1 of the present embodiment, the temperature of the growing section 20 can be adjusted using the ground temperature because the liquid LQ is guided from the storage section 10 located in the ground G2. As a result, the cost of adjusting the temperature of the growing section 20 can be controlled.

As shown in FIG. 6, the growing section 20 has a main body 21. The body part 21 includes a side plate 21A and a bottom plate 21B. The side panels 21A and the bottom panel 21B form a growing area. In the growing area, for example, soil or water is placed. For example, plants, insects, or fish, which are organisms LF, are arranged in the growing area. For example, fertilizer may be placed in the growing area.

The plurality of cylindrical sections transmits light. The plurality of cylindrical sections is transparent or translucent. Therefore, for example, sunlight can reach the growing section 20. In other words, sunlight can shine on the organism LF that is growing in the growing section 20. As a result, the organism LF can be grown using the light transmitted through the cylindrical section 30. It is more preferable that the plurality of cylindrical sections 30 be transparent. If it is not necessary to allow sunlight to reach the growing section 20, a sheet that does not transmit light may be attached to the tube section 30.

The plurality of cylindrical sections 30 is made of resin, for example. The resin is preferably polyethylene terephthalate (PET), for example. For example, by configuring the cylindrical sections 30 with polyethylene terephthalate (PET), the outer surface 62 of the housing portion 60 can be protected.

As shown in FIGS. 6 and 7, each of the plurality of cylindrical sections 30 includes a plurality of cylindrical bodies 31. The cylindrical body 31 corresponds to an example of a “passage body”. The plurality of cylindrical bodies 31 are connected in series. For example, when a leak of liquid LQ occurs in the cylindrical section 30, the cylindrical body 31 at the location where the leak of liquid LQ occurs among the plurality of cylindrical bodies 31 can be replaced. In other words, there is no need to replace all the cylinders that have leaked liquid LQ. Therefore, the maintenance of the cylinder section 30 becomes easier. As a result, the time and effort required for maintenance can be reduced.

Specifically, as shown in FIG. 7, the plurality of cylindrical bodies 31 includes, for example, cylindrical bodies 301A to 301F. Since the plurality of cylindrical bodies 31 have the same configuration, cylindrical bodies 301A to 301F will be described as examples, and the description of the other cylindrical bodies 31 will be omitted.

Each of the cylinders 301A through 301F has a first open end and a second open end. The first open end is the open end on the first direction A1 side. The second open end is the open end on the second direction A2 side. In other words, by connecting the cylinders 301A to 301F in series, the cylinders 301A to 301F are connected.

The first open end of the cylinder 301A is connected to the guide section 40 that connects the storage section 10 to the cylinder section 30. The second open end of the cylinder 301A is connected to the first open end of the cylinder 301B. The second open end of the cylindrical body 301B is connected to the first open end of the cylindrical body 301C. The second open end of the cylindrical body 301D is connected to the first open end of the cylindrical body 301E. The second open end of the cylindrical body 301E is connected to the first open end of the cylindrical body 301F. The second open end of the cylindrical body 301F is connected to the guide section 40 that connects the cylindrical section 30 to the storage section 10.

In other words, the liquid LQ flows in from the first open end of the cylinder 301A. Then, the liquid LQ passes through the flow path composed of the cylindrical body 301A and the cylindrical body 301F. Furthermore, the liquid LQ flows out from the second open end of the cylinder 301F to the guide section 40. The first open end of the cylinder body 301A corresponds to the first end of the cylinder section 30, and the second open end of the cylinder body 301F corresponds to the second end of the cylinder section 30.

The plurality of cylinders 31 may, for example, be made from plastic bottles. Specifically, the mouth and bottom of the PET bottle are cut off to make the PET bottle into a cylindrical shape. Then, a plurality of cylindrical PET bottles are connected in series. In other words, the cylindrical PET bottles correspond to the 31 cylindrical bodies. The plurality of cylindrical PET bottles connected in series corresponds to the cylindrical part 30. Only the bottom of the PET bottle may be cut off to allow connection to the guide section 10. The cylindrical body 31 and the cylinder 31 are fixed with adhesive material.

The heat retention system 1 will now be described in more detail with reference to FIG. 6 and FIG. 7. The heat retention system 1 is further equipped with a housing section 60.

The housing section 60 accommodates the growing section 20. Specifically, the storage section 60 accommodates the growing part 20 inside the storage section 60. The storage section 60 corresponds to an example of the “second storage section.

The storage section 60 has a main body section 60A and a lid section 60B. The main body part 60A accommodates the growing part 20 inside. The main body portion 60A is cylindrical in shape. The end of the body part 60A is an open end.

The main body of the housing section 60A has an inner surface 61 and an outer surface 62. The inner surface 61 is the wall surface of the inner space of the housing section 60. The outer surface 62 is the wall surface of the exterior of the housing section 60. The plurality of cylindrical portions 30 are arranged on the outer surface 62. In other words, the plurality of cylindrical sections 30 are arranged along the outer surface 62 of the housing section 60. In other words, the plurality of cylindrical sections 30 through which the liquid LQ maintained at a predetermined temperature passes come into contact with the outer surface 62 of the housing section 60. Therefore, the temperature of the growing section 20 located on the inner surface 61 side of the housing section 60 can be changed using the liquid LQ of a predetermined temperature. Therefore, the temperature of the growing part 20 can be changed without using a heating device and a cooling device. As a result, the cost of adjusting the temperature of the growing section 20 according to the season can be reduced.

For example, using the liquid LQ that has become the temperature according to the depth from the ground surface G1, the temperature of the growing section 20 can be adjusted to match the season, even in summer when the temperature is high. The temperature of the growing section 20 can be adjusted according to the season, even in winter when the temperature is low, by using the liquid LQ that has become the temperature according to the depth from the ground surface G1. In other words, the temperature of the growing section 20 can be adjusted to grow the organism LF regardless of the season.

For example, in the case of plants that grow slowly due to lower temperatures, the temperature of the growing section 20 can be adjusted, allowing the plants to grow regardless of the season. Therefore, the grown plants can be harvested regardless of the season. It is also possible to use the grown plants as food for insects.

For example, in the case of insects that hibernate due to low temperatures, the temperature of the growing section 20 can be adjusted, thus preventing the insects from hibernating. By preventing the insects from hibernating, the insects can be made to grow further. Also, because the temperature can be adjusted, the insects can be encouraged to grow and lay eggs. In addition, the grown insects can be used as food for fish.

For example, when growing fish in the growing section 20, the temperature of the growing section 20 can be adjusted, so that fish can be grown regardless of the season. Thus, because the temperature can be adjusted, the growth and spawning of fishes can be promoted.

The lid portion 60B blocks the open end of the main body portion 60A. The lid 60B blocks the open end located on the first direction A1 side of the main body 60A. The lid 60B blocks the open end located on the second direction A2 side of the main body 60A. Thus, the housing portion 60 can accommodate the growing portion 20 in an enclosed space. Therefore, the organism LF being cultivated in the growing section 20 can be prevented from coming into contact with the organism located outside the housing section 60. As a result, it is possible to prevent the organism LF grown in the growing section 20 from interbreeding with the organisms located outside the housing section 60. For example, when the organism LF grown in the growing section 20 is a plant, seeds (pollen) from outside the housing section 60 can be prevented from entering the inside of the housing section 60.

The size of the housing section 60 corresponds to the size of the growing section 20. For example, when heating the inside of the housing section 60, if the space inside the housing section 60 is larger than necessary, it takes time to heat the inside of the housing section 60. In other words, the efficiency of heating the inside of the compartment 60 is poor. In addition, when cooling the inside of the compartment 60, if the space inside the compartment 60 is larger than necessary, it takes more time to cool the inside of the compartment 60. In other words, the efficiency of cooling the inside of the compartment 60 is poor. Therefore, the size of the housing section 60 is determined according to the size of the growing section 20 or the organism LF to be grown.

The housing section 60 may have a supply section. The supply section, for example, supplies water to the growing section 20. The supply section also supplies, for example, fertilizer to the growing section 20. The supply section, for example, supplies water and fertilizer to the growing section 20. The supply section is in the form of a pipe. The water and fertilizer are supplied to the growing section 20 through the pipe. The housing section 60 may be located outside the cylinder section 30. In other words, the cylinder section 30 may be located inside the housing section 60.

Next, with reference to FIGS. 1-3, the heat retention system 1 will be described in further detail. As shown in FIGS. 2 and 3, the heat retention system 1 is further equipped with a switching section 80.

The switching section 80 switches the source of supply of the liquid LQ that is guided toward the plurality of cylindrical sections 30. Specifically, the switching section 80 switches the source of supply from the storage section 10 that is set as the source of supply among the plurality of storage sections 10 to another storage section 10. The temperature of the liquid LQ stored in the storage section 10 is changed to a temperature corresponding to the depth of the storage section 10 from the ground surface G1. In other words, the temperature of the liquid LQ guided to the plurality of cylindrical sections 30 can be changed by the switching section 80 switching the source of the liquid LQ guided toward the plurality of cylindrical sections 30. Therefore, the temperature of the liquid LQ guided to the plurality of cylindrical sections 30 can be changed to adjust the temperature of the interior of the growing section 20 side. As a result, temperature adjustment of the inside of the growing section 20 side becomes easy.

For example, as shown in FIG. 3, the switching section 80 switches the source of supply from the first storage section 10A, which is set as the source of supply, to the second storage section 10B. For example, the temperature of the liquid LQ in the first storage section 10A is “20° C.”. As the liquid LQ in the first storage section 10A is guided by the plurality of cylinders 31, the temperature on the side of the growing section 20 becomes “20 degrees”. On the other hand, the temperature of the liquid LQ in the second storage section 10B is “17 degrees”. As the liquid LQ in the first storage section 10A is guided by the plurality of cylinders 31, the temperature on the side of the growing section 20 becomes “17 degrees”. By switching the second storage section 10B to the source of liquid LQ, the temperature of the growing section 20 side can be changed.

For example, the switching section 80 may switch the source of supply from the first storage section 10A, which is set as the source of supply, to the second storage section 10B based on the season. For example, if the season is summer, the switching section 80 switches the source of supply from the first storage section 10A, which is set as the source of supply, to the third storage section 10C. For example, the temperature of the liquid LQ in the first storage section 10A is “20° C.”. On the other hand, the temperature of liquid LQ in the third storage section 10C is “15 degrees”. In other words, the temperature of the liquid LQ in the first storage section 10A is “15 degrees” on the side of the growing section 20 as it is guided by the plurality of cylinders 31. Therefore, the temperature on the side of the growing section 20 can be changed by switching the second storage section 10B to the source of the liquid LQ. As a result, the source of the liquid LQ can be changed according to the season, and the organism LF can be grown efficiently.

As shown in FIG. 3, the switching section 80 has a first valve plug 81A, a first valve plug 81B, and a third valve plug 81C.

The first valve plug 81A opens and closes the outlet of the first storage section 10A. When the first valve plug 81A opens the outlet of the first storage section 10A, liquid LQ flows from the first storage section 10A to the first guide section 41A. In other words, the liquid LQ stored in the first storage section 10A is guided to the plurality of cylindrical sections 30. The first valve plug 81A blocks the outlet of the first storage section 10A, thereby preventing the liquid LQ from flowing from the first storage section 10A to the first guiding section 41A.

The first valve plug 81B opens and closes the outlet of the second storage section 10B. When the first valve plug 81B opens the outlet of the second storage section 10B, liquid LQ flows from the second storage section 10B to the first guide section 41B. In other words, the liquid LQ stored in the second storage section 10B is guided to the plurality of cylindrical sections 30. The first valve plug 81B blocks the outlet of the second storage section 10B, thereby preventing the liquid LQ from flowing from the second storage section 10B to the first guiding section 41B.

The third valve plug 81C opens and closes the outlet of the third storage section 10C. When the third valve plug 81C opens the outlet of the third storage section 10C, liquid LQ flows from the third storage section 10C to the first guide section 41C. In other words, the liquid LQ stored in the third storage section 10C is guided to the plurality of cylindrical sections 30. The third valve plug 81C closes the outlet of the third storage section 10C, thereby preventing the liquid LQ from flowing from the third storage section 10C to the first guiding section 41C.

When the first valve plug 81A is opening the outlet of the first storage section 10A, the first valve plug 81B closes the outlet of the second storage section 10B, and the third valve plug 81C closes the outlet of the third storage section 10C. When the first valve plug 81B opens the outlet of the second storage section 10B, the first valve plug 81A closes the outlet of the first storage section 10A and the third valve plug 81C closes the outlet of the third storage section 10C. When the third valve disc 81C is opening the outlet of the third storage section 10C, the first valve disc 81A closes the outlet of the first storage section 10A and the first valve disc 81B closes the outlet of the second storage section 10B.

The heat retention system 1 of this embodiment will now be described in further detail with reference to FIGS. 1 through 7. As shown in FIGS. 1 to 7, the heat retention system 1 is further equipped with a moving section 70. The moving section 70 moves the growing section 20. Therefore, the growing section 20 contained in the housing section 60 can be easily moved. As a result, the growing section 20 can be easily moved when cleaning the inside of the housing section 60 and harvesting the organisms LF grown in the growing section 20.

In addition to the organisms LF, the growing area 20 contains soil or water. In other words, the weight of the organism LF and soil, or the weight of the organism LF and water, makes it difficult to move the growing section 20. However, even if the weight of the growing section 20 increases, the moving section 70 can move the growing section 20. For example, even if the weight of the growing section 20 increases, the moving section 70 can be moved to clean the inside of the housing section 60. Also, even if the weight of the growing section 20 increases, the moving section 70 can be moved to harvest the organisms LF grown in the growing section 20.

Furthermore, when the growing section 20 is housed in the housing section 60, it may be difficult for an operator to work inside the housing section 60. However, the moving section 70 can move the growing section 20 to a position where harvesting of the grown organism LF is easy. Therefore, the operator can harvest the organism LF at a position where harvesting is easy. As a result, the harvesting of the organisms LF grown in the growing section 20 becomes easier.

As shown in FIGS. 6 and 7, the moving section 70 has a loading section 71, tires 72, a pair of rails 73, a connecting section 75, and a driving section 76.

The loading section 71 is a flat plate on which the growing section 20 is placed. The mounting part 71 is a flat plate. The mounting part 71 contacts the bottom of the growing part 20 and supports the growing part 20.

The tire 72 rolls. The tire 72 moves the loading section 71. Specifically, the tire 72 moves the mounting portion 71 along the pair of rails 73. In other words, as the tire 72 moves along the pair of rails 73, the growing part 20 placed on the placing part 71 moves.

The pair of rails 73 guides the loading section 71. Specifically, the pair of rails 73 guides the placing portion 71 in the first direction A1 or the second direction A2 as the tire 72 moves along the pair of rails 73. The pair of rails 73 are disposed on the bottom surface of the housing section 60.

The connecting portion 75 connects the loading portion 71 and the loading portion 71 adjacent to each other. The connecting portion 75 has a first connecting member 75A and a second connecting member 75B. The first connecting member 75A is located at the end of the first direction A1 of the placing portion 71. The second connecting member 75B is located at the end of the second direction A2 of the mounting portion 71. The first connecting member 75A is connected to the second connecting member 75B of the mounting portion 71 adjacent to each other. By connecting the placing sections 71 adjacent to each other with the first connecting member 75A and the second connecting member 75B, the placing sections 71 are connected in series as shown in FIG. 6. Therefore, by moving the connected loading sections 71, a plurality of growing sections 20 placed on the loading sections 71 can be moved. As a result, the time and effort required to move the 71 loading sections one by one can be reduced.

The drive unit 76 pulls the placing part 71. Specifically, the drive unit 76 pulls the placing part 71 toward the second direction A2. More specifically, the drive unit 76 pulls the connected loading section 71 toward the second direction A2. The drive unit 76 is, for example, a winch. Therefore, even if the placing sections 71 are connected and their weight increases, the placing sections 71 can be pulled toward the second direction A2. As a result, the plurality of growing sections 20 can be easily moved.

The drive unit 76 has a third connecting member 76A. The third connecting member 76A is connected to the first connecting member 75A or the second connecting member 75B. The third connecting member 76A is, for example, a string. For example, the third connecting member 76A is connected to the first connecting member 75A shown in FIG. 6.

The moving section 70 may further have a drive section 76 on the side in the first direction A1. The drive portion 76 located on the side of the first direction A1 pulls the placing portion 71 toward the first direction A1. For example, when the housing section 60 is inclined, the placing section 71 on which the growing section 20 is placed may move under its own weight according to gravity. The moving section 70 may have an auxiliary roller. The auxiliary rollers contact the side of the housing section 60 to guide the placing section 71.

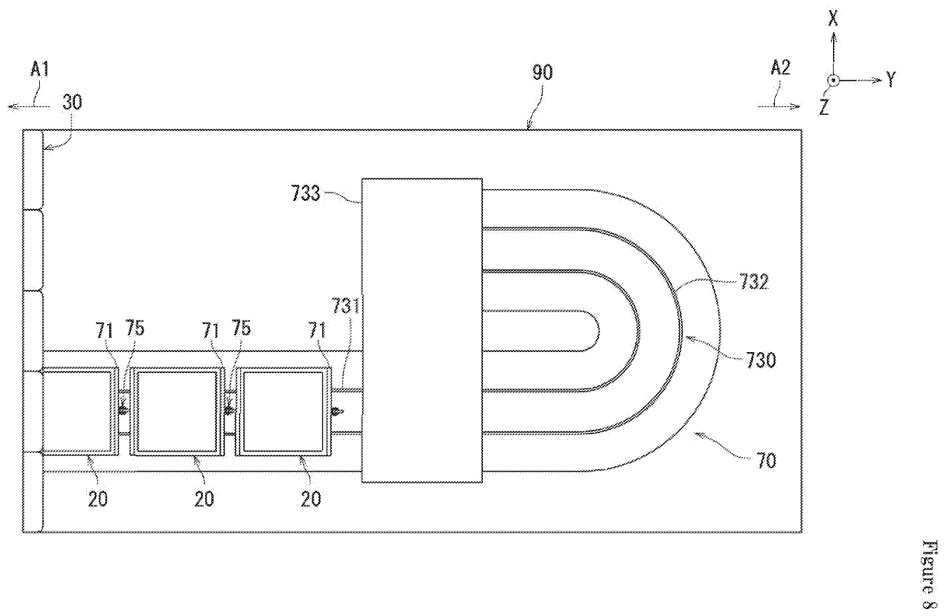

Next, with reference to FIGS. 4 through 8, the heat retention system 1 of this embodiment will be described in further detail. FIG. 8 shows the workroom 90 of the heat retention system 1 of this embodiment.

As shown in FIG. 8, the growing section 20 is transported to the workroom 90. The growing section 20 transported to the workroom 90 is used by workers to harvest organisms LF, observe organisms LF, maintain the growing section 20, and clean the growing section 20.

The moving section 70 is further equipped with a pair of rails 730. The pair of rails 730 guides the loading section 71. As shown in FIG. 8, the pair of rails 730 is disposed in the work chamber 90. For example, when harvesting the organism LF grown in the growing section 20, the lid 60B of the housing section 60 is opened to connect the interior space of the housing section 60 with the interior space of the working room 90. Then, the growing section 20 is moved to the working room 90. Thus, the operator can harvest the organisms LF while moving the loading section 71 along the pair of rails 730. The organism LF grown in the working room 90 can be harvested. As a result, the organism LF grown in the growing section 20 can be harvested efficiently.

The pair of rails 730 has a straight section 731, a curved section 732, and a path changing section 733.

The straight line portion 731 guides the placing portion 71. For example, the straight portion 731 guides the placing portion 71 in the first direction A1 or the second direction A2. The straight portion 731 is connected to the curved portion 732.

The curved portion 732 guides the placing portion 71. The curved portion 732 guides the placing portion 71 from the second direction A2 to the first direction A1. In other words, the curved portion 732 changes the direction of travel of the placing portion 71. For example, the curved portion 732 changes the movement direction of the placing portion 71 from the second direction A2 to the first direction A1. In other words, the curved portion 732 changes the direction of movement of the placing portion 71 from the second direction A2 to the first direction A1, and guides the placing portion 71 in the first direction A1.

The path changing section 733 changes the path of the placing section 71. Specifically, the path changing section 733 changes the path of the placing section 71 from the curved section 732 to the straight section 731. That is, the placing part 71 on which the growing part 20 that has been harvested is placed is guided in the straight part 731 toward the first direction A1. In other words, the loading section 71 is guided to the housing section 60.

### Form 2.

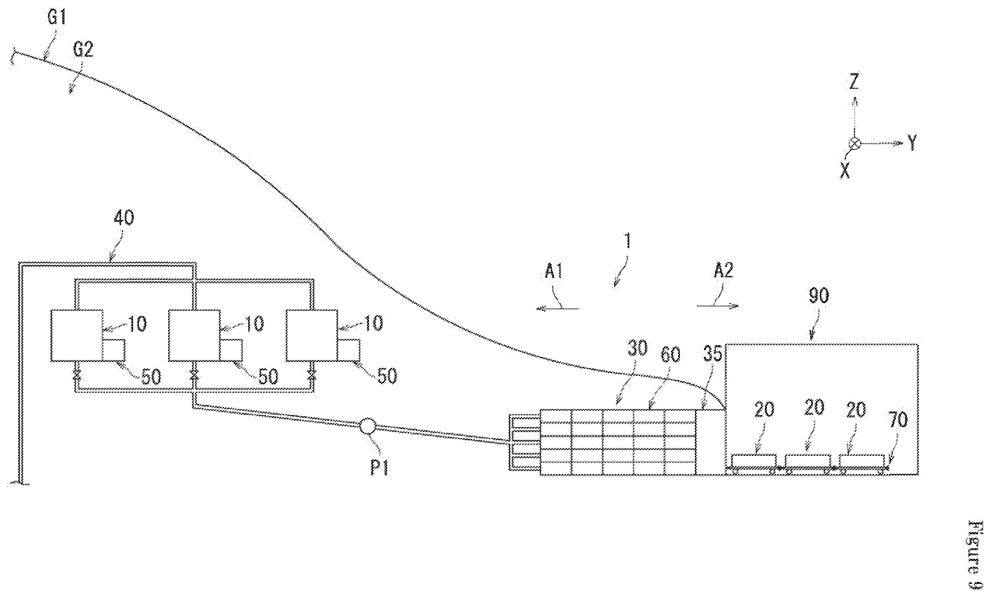

Next, referring to FIG. 2 and FIG. 9, the heat retention system 1 of embodiment 2 will be described. The heat insulation system 1 of embodiment 2 differs from the heat insulation system 1 of embodiment 1 in that the housing 60 is located in the ground G2. In the following, the matters of Embodiment 2 that differ from those of Embodiment 1 will be explained, and explanations of the parts that overlap with those of Embodiment 1 will be omitted.

FIG. 9 is a schematic diagram of the heat retention system 1 of embodiment 2. As shown in FIG. 2 and FIG. 9, the heat retention system 1 of embodiment 2 has a storage section 10, a growing section 20, a tube section 30, a guiding section 40, a temperature control section 50, a storage section 55, a storage section 56, a housing section 60, a passage 35, a working chamber 90, a first pump P1, and a second pump P2.

The storage section 10 stores the liquid LQ. The growing section 20 grows the organism LF. The cylinder 30 constitutes a flow path for the liquid LQ. The guide section 40 guides the liquid LQ stored in the storage section 10 to the cylinder section 30. The temperature control section 50 adjusts the temperature of the liquid LQ stored in the storage section 10. The storage section 55 stores the liquid LQ that flows out of the plurality of cylinder sections 30. The storage section 56 stores the liquid LQ that has flowed out from the plurality of cylinder sections 30. The storage section 60 accommodates the growing section 20. The passage 35 connects the storage section 60 to the working chamber 90. The working room 90 is where the growing section 20 is transported. The first pump P1 transfers the liquid LQ flowing out of the storage section 10 toward the plurality of cylinders 30. The second pump P2 transfers the liquid LQ flowing out of the storage section 55 toward the storage section 10.

As shown in FIG. 9, the housing section 60 of Embodiment 2 is located in the ground G2. This means that the temperature of the housing section 60 can be set to a temperature corresponding to the depth of the housing section 60 from the ground surface G1. Therefore, the temperature of the housing section 60 can be adjusted based on the temperature corresponding to the depth from the ground surface G1. As a result, the temperature of the housing section 60 can be easily adjusted.

The cylinder 30 is located in the ground G2. This means that the cylinder 30 is not exposed to the ground surface G1. Therefore, it is possible to suppress the temperature of the liquid LQ passing through the cylinder 30 from becoming the same temperature as the outside temperature. As a result, the temperature of the liquid LQ passing through the cylinder section 30 can be prevented from changing.

The guide section 40 is located in the ground G2. In other words, the guide section 40 is not exposed to the ground surface G1. Therefore, it is possible to prevent the temperature of the liquid LQ guided by the guide section 40 from becoming the same temperature as the outside temperature. As a result, liquid LQ of a stable temperature can be guided into the cylinder section 30.

### Form 3.

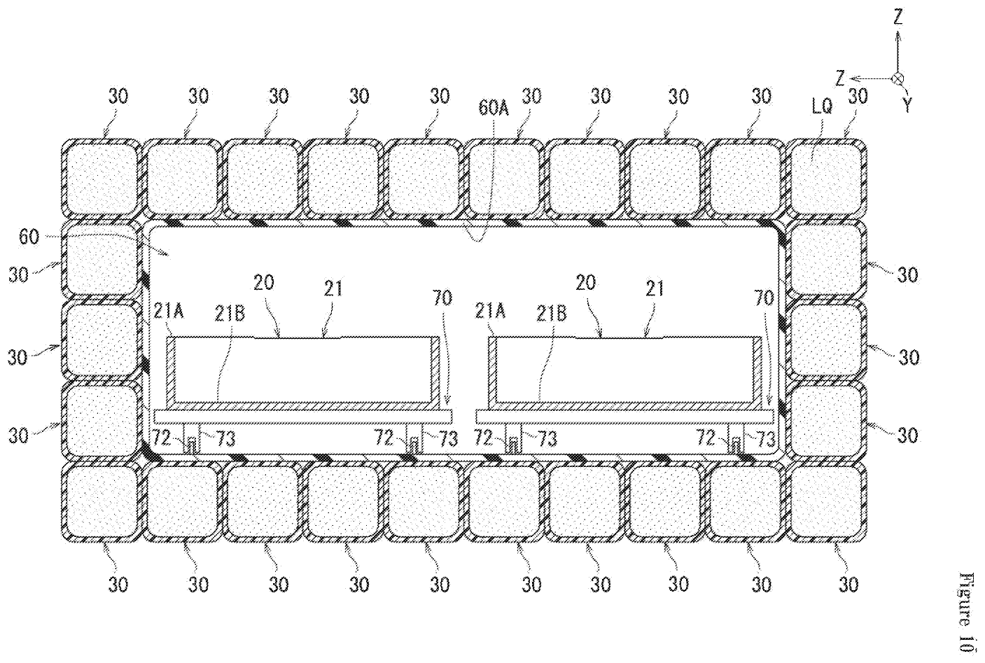

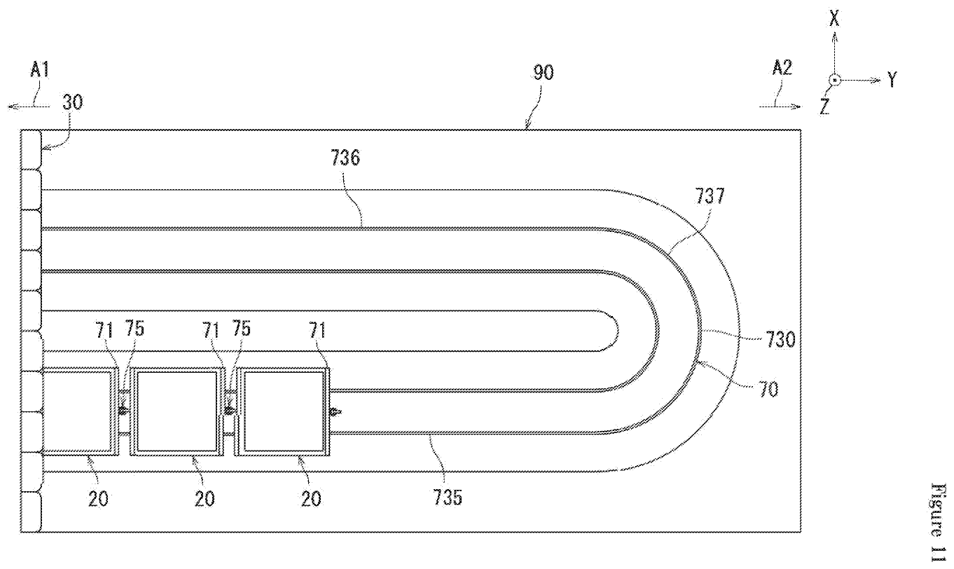

Next, referring to FIG. 10 and FIG. 11, the heat-retention system 1 of embodiment 3 will be described. The heat-retention system 1 of embodiment 3 differs from the heat-retention system 1 of embodiment 1 and embodiment 2 in that there are multiple rows of growing sections 20 inside the housing section 60. In the following, matters of Embodiment 3 that differ from those of Embodiment 1 and Embodiment 2 will be described, and explanations of parts that overlap with those of Embodiment 1 and Embodiment 2 will be omitted.

FIG. 10 shows the housing 60 of the heat retention system 1 according to the invention of embodiment 3. FIG. 11 shows the working room 90 of the heat retention system 1 according to the invention of embodiment 3. In FIG. 10, there are two rows of growing sections 20 connected in series. In FIG. 11, a pair of rails 730 arranged in the working room 90 is shown.

The moving section 70 shown in FIG. 10 has a plurality of pairs of rails 73. The pairs of rails 73 guide the loading section 71. The plurality of pairs of rails 73 are disposed on the bottom surface of the housing section 60. Each of the plurality of pairs of rails 73 has a loading section 71 connected to it in series. The series-connected loading sections 71 move along the corresponding pairs of rails 73. This means that the loading section 71 and the loading section 71 of the adjacent row do not come into contact with each other in the housing section 60. Therefore, it is possible to suppress the movement of the loading section 71 from being restricted due to contact between the loading section 71 and the loading sections 71 of adjacent rows. As a result, the loading section 71 can be easily moved inside the housing section 60.

As shown in FIG. 11, a pair of rails 730 is arranged in the work chamber 90 of embodiment 2. The moving section 70 of embodiment 2 is further provided with a U-shaped pair of rails 730. The pair of rails 730 guides the placing portion 71. Specifically, the pair of rails 730 guides the placing portion 71 located in the working chamber 90. The pair of rails 730 has a first straight portion 735, a second straight portion 736, and a curved portion 737.

The first straight section 735 guides the loading section 71. The first straight portion 735 is connected to the curved portion 737. For example, the first straight portion 735 guides the placing portion 71, which is guided by the curved portion 737 to the first straight portion 735, in the first direction A1. In other words, the first straight portion 735 guides the placing portion 71 into the housing portion 60. For example, the first straight section 735 guides the loading portion 71 guided from the housing section 60 into the work chamber 90 in the second direction A2.

The second straight section 736 guides the loading section 71. The second straight portion 736 is connected to the curved portion 737. For example, the second straight portion 736 guides the placing portion 71, which is guided by the curved portion 737 to the second straight portion 736, in the first direction A1. In other words, the second straight portion 736 guides the placing portion 71 into the housing portion 60. For example, the second straight section 736 guides the loading portion 71 guided from the housing portion 60 into the work chamber 90 in the second direction A2.

The curved portion 737 guides the placing portion 71. The curved portion 737 guides the placing portion 71 from the second direction A2 toward the first direction A1. The curved portion 737 also guides the mounting portion 71 from the first direction A1 to the second direction A2. In other words, the curved portion 737 changes the direction of travel of the placing portion 71. For example, the curved portion 737 changes the direction of movement of the placing portion 71 from the second direction A2 to the first direction A1. Also, for example, the curved portion 737 changes the movement direction of the placing portion 71 from the second direction A2 to the first direction A1. In other words, the curved portion 737 changes the movement direction of the placing portion 71 and guides the placing portion 71 to the first straight portion 735 or the second straight portion 736.

For example, the loading section 71 that moves from the housing section 60 to the working chamber 90 moves along the pair of rails 730 in the working chamber 90. In other words, the loading section 71 moves in a U-shape along the pair of rails 730 in the workroom 90. Furthermore, by moving the placing section 71 along the U-shaped pair of rails 73, the placing section 71 is again accommodated inside the housing section 60. By moving the placing section 71 along the U-shaped pair of rails 730, for example, the placing section 71 with the growing section 20 that has not been harvested can be moved to the work room 90 while the placing section 71 with the growing section 20 that has been harvested can be accommodated in the housing section 60.

### Form 4.

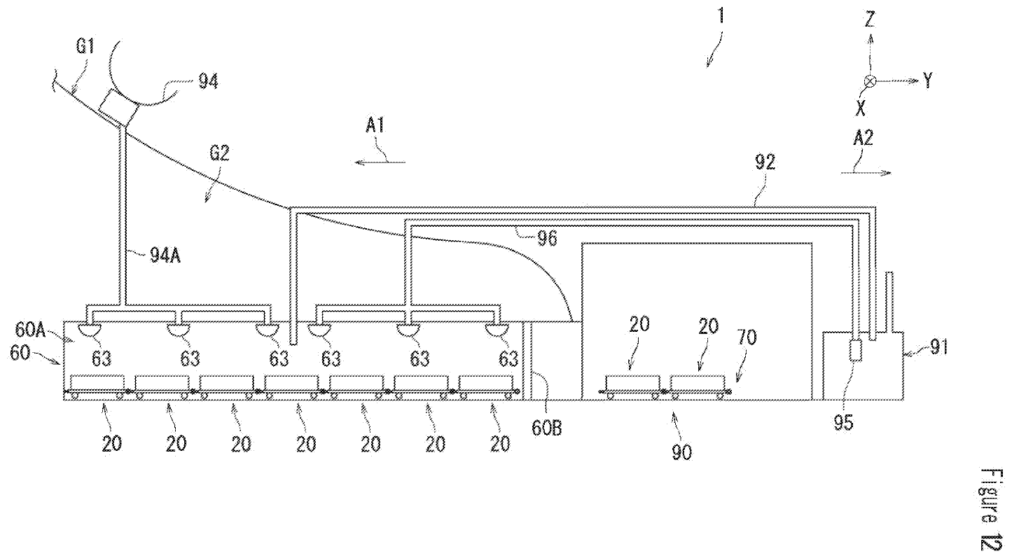

Next, referring to FIGS. 12 to 14, the heat retention system 1 of embodiment 4 will be described. The heat insulation system 1 of embodiment 4 differs from the heat insulation system 1 of embodiment 1 to embodiment 3 in that the storage section 10 and the cylinder section 30 are not provided and the housing section 60 is located in the ground G2. The following describes the matters of embodiment 4 that differ from those of embodiments 1 to 3, and omits explanations of the parts that overlap with those of embodiments 1 to 3.

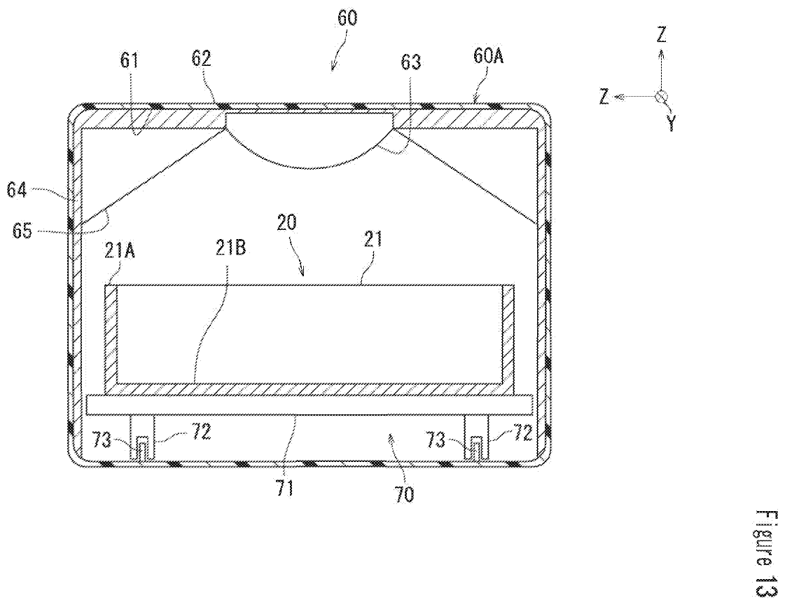

FIG. 12 schematically shows the heat retention system 1 according to embodiment 4. FIG. 13 shows a housing section 60 of the heat retention system 1 according to embodiment 4. As shown in FIG. 12, the heat retention system 1 according to embodiment 4 has a growing section 20, a housing section 60, a moving section 70, a passage 35, a working room 90, a heating section 91, an introduction section 92, a light-collecting section 93, a first light guide section 94, a thermal radiation member 95, and a second light guide section 96.

The growing section 20 grows the organism LF. The storage section 60 accommodates the growing section 20. The moving part 70 moves the growing part 20. The passageway 35 connects the storage section 60 to the work room 90. In the work room 90, the growing part 20 is transported.

The housing 60 shown in FIG. 12 and FIG. 13 has a main body part 60A and a lid part 60B. The main body part 60A has a light emitting part 63, a heat insulating member 64, and a reflective member 65.

The light emitting part 63 emits light. Specifically, the light emitting part 63 emits light that is guided from the first light guide 94. In addition, the light emitting part 63 emits light guided by the second light guide 96. The light emitting part 63 is, for example, a reflective member. In other words, the light-emitting part 63 reflects the light guided to the light-emitting part 63 by the first light guide part 94 toward the growing part 20. The light-emitting part 63 also reflects the light guided to the light-emitting part 63 by the second light guide 96 toward the growing part 20. The light-emitting portion 63 is disposed in the ceiling portion of the housing portion 60.

The insulating material 64 prevents the transfer of heat. The heat insulating material 61 is, for example, glass wool. It is preferable that the heat insulating material 64 be a material with low thermal conductivity. The heat insulating member 64 can suppress the temperature change in the housing 60.

The reflective member 65 reflects the light emitted from the light-emitting portion 63. Specifically, the reflective member 65 suppresses the light emitted from the light-emitting portion 63 from returning toward the light-emitting portion 63. In other words, the reflective member 65 reflects the light emitted from the light-emitting part 63 back to the growing part 20. Therefore, the light can be efficiently irradiated to the growing section 20. As a result, the plants growing in the growing section 20 can be efficiently grown. It is preferable that the reflective member 65 is a mirror surface.

The heating section 91 heats the wood and burns the wood. The heating section 91 is placed on the ground surface G1. The wood is placed inside the heating unit 91. The wood heated by the heating unit 91 generates carbon dioxide. The generated carbon dioxide is guided to the introduction section 92. By heating the wood, the heating unit 91 heats the thermal radiation member 95.

The introduction section 92 introduces the carbon dioxide generated by the heating section 91 into the housing section 60. For example, the introduction section 92 has a fan and piping. By rotating the fan, the carbon dioxide generated in the heating section 91 is introduced through the piping to the housing section 60. Therefore, when the organism LF to be grown in the growing section 20 is a plant, the growth of the plant can be promoted. As a result, the plants can be grown efficiently. The heating section 91 may be placed in the ground G2.

The light-collecting part 93 collects sunlight. The light-collecting part 93 has a reflective member. The reflective component is, for example, a parabolic concave mirror. The parabolic concave mirror changes its orientation to follow the position of the sun.

The first light guide 94 guides the sunlight collected by the light-collecting part 93 to the light-emitting part 63. The first light guide 94 is, for example, an optical fiber. The optical fiber reflects the light collected by the light-collecting portion 93 and leads it to the light-emitting portion 63. The sunlight guided to the light-emitting portion 63 by the first light guide portion 94 is emitted from the light-emitting portion 63 to the growing portion 20.

The thermal radiation component 95 generates electromagnetic waves. Specifically, the thermal radiation component 95 generates electromagnetic waves by heating. The electromagnetic wave is, for example, light. In other words, the thermal radiation component 95 is a thermal radiation light source. Therefore, the thermal radiation component 95 emits light.

The second light guide 96 guides the light emitted by the thermal radiation member 95 to the light emitting part 63. The second light guide 96 is, for example, an optical fiber. The optical fiber reflects the light emitted by the thermal radiation member 95 and guides it to the light-emitting part 63. The light guided to the light-emitting portion 63 by the second light guide portion 96 is emitted from the light-emitting portion 63 toward the growing portion 20.

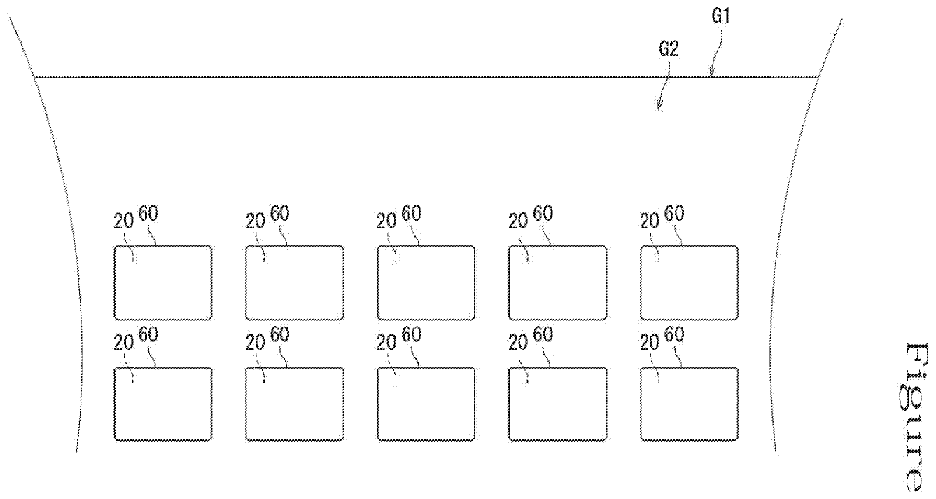

Next, referring to FIG. 14, the housing section 60 of embodiment 4 will be described in further detail. FIG. 14 shows a heat retention system 1 with a plurality of housing sections 60 according to embodiment 4. In FIG. 14, a plurality of accommodation sections 60 located in the ground G2 are shown. Therefore, the temperature of the plurality of housing sections 60 can be set to a temperature corresponding to the depth of the housing sections 60 from the ground surface G1. As a result, the temperature of the plurality of housing sections 60 can be easily adjusted.

Each of the plurality of housing sections 60 accommodates a plurality of growing sections 20. Therefore, as the number of housing sections increases, the number of organisms LF to be grown increases. As a result, the number of organisms LF harvested can be increased.

### Form 5.

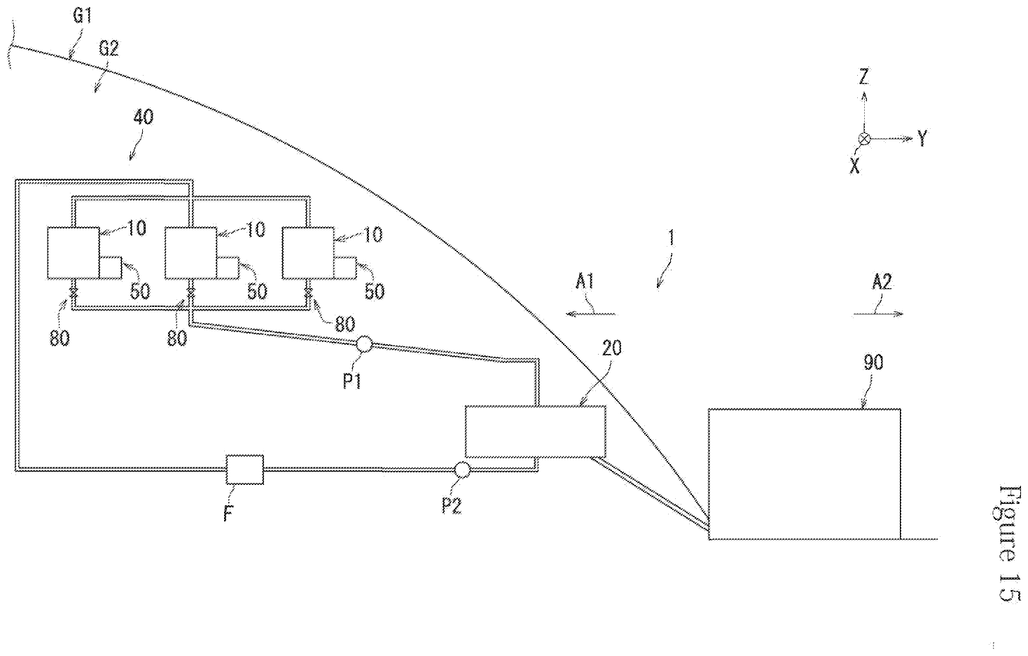

Next, referring to FIG. 3 and FIG. 15, the heat retention system 1 of embodiment 5 will be described. The heat retention system 1 of Embodiment 5 differs from the heat retention systems 1 of Embodiment 1 to Embodiment 4 in that the growing section 20 is a water tank. The following describes the matters of Embodiment 5 that are different from those of Embodiments 1 to 4, and omits explanations of the parts that overlap with those of Embodiments 1 to 4.

The heat retention system 1 of embodiment 5 has a plurality of storage sections 10, a growing section 20, a guiding section 40, a temperature control section 50, a switching section 80, a working room 90, a first pump P1, a second pump P2, and a filtration section F.

Each of the plurality of reservoirs 10 stores a liquid LQ. The liquid LQ may be fresh water or seawater. As shown in FIG. 3, each of the plurality of reservoirs 10 is located at a predetermined depth D from the ground surface G1. The guide section 40 connects the storage section 10 to the growth section 20. The growing section 20 grows organisms LF. The temperature control section 50 adjusts the temperature of the liquid LQ. The working room 90 carries the organism LF.

The switching section 80 switches the source of supply of the liquid LQ that is guided toward the growing section 20. Specifically, the switching section 80 switches the source of supply from the storage section 10 that is set as the source of supply among the plurality of storage sections 10 to another storage section 10. The temperature of the liquid LQ stored in the storage section 10 is changed to a temperature corresponding to the depth of the storage section 10 from the ground surface G1. In other words, the temperature of the liquid LQ guided to the growing section 20 can be changed by the switching section 80 switching the source of the liquid LQ guided toward the growing section 20. Therefore, the temperature of the growing section 20 can be adjusted by changing the temperature of the liquid LQ guided to the growing section 20. As a result, the temperature of the growing section 20 can be easily adjusted.

The first pump P1 transfers the liquid LQ. Specifically, the first pump P1 transfers the liquid LQ that has flowed out of the storage section 10 toward the growing section 20.

The second pump P2 transfers the liquid LQ. Specifically, the second pump P2 transfers the liquid LQ that has flowed out of the growing section 20 toward the storage section 10.

The growing section 20 of Embodiment 5 grows fishes. The growing section 20 also stores liquid LQ. The growing section 20 is, for example, a water tank. The water tank is, for example, rectangular in shape. The shape of the water tank may be, for example, a cylindrical shape. The shape of the water tank may also be annular. The size of the water tank is based on the size of the fish. The growing section 20 is located in the ground G2.

The filtration section F filters the liquid LQ. Specifically, the filtration section F filters the liquid LQ that passes through the filtration section F.

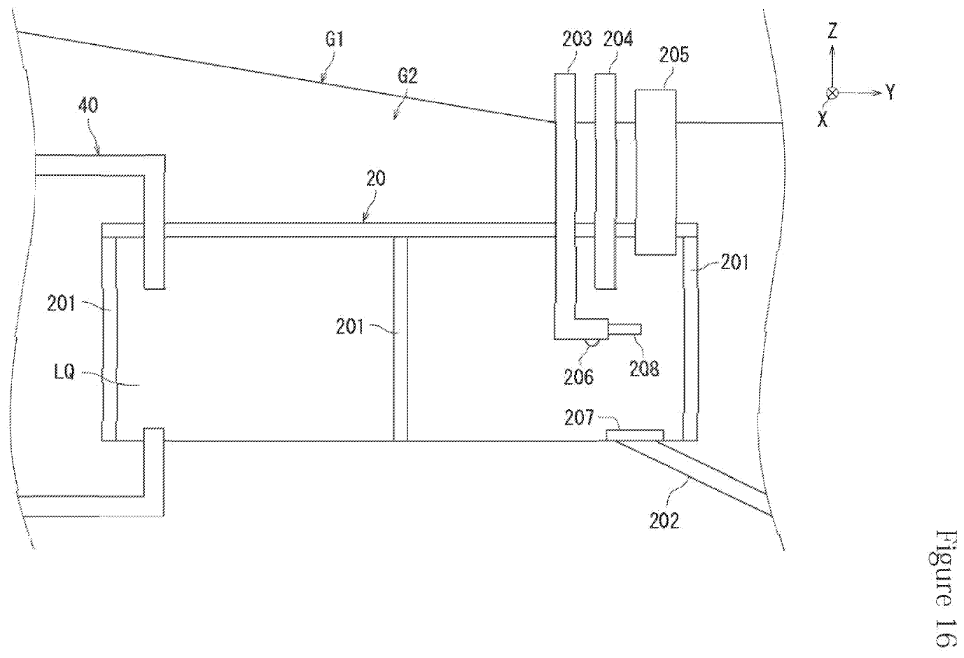

Next, referring to FIG. 15 and FIG. 16, the growing section 20 of Embodiment 5 will be described in detail. FIG. 15 schematically shows the heat retention system 1 according to Embodiment 5. FIG. 16 is an enlarged view of the growing section 20 of the heat retention system 1 according to embodiment 5. The growing section 20 shown in Embodiment 5 includes a plurality of supports 201, a first piping 202, a second piping 203, a third piping 204, and a fifth piping 205.

The plurality of supports 201 supports the ceiling portion of the growing section 20.

The first piping 202 connects the growing section 20 to the working chamber 90. Specifically, the first piping 202 connects the breeding section 20 to the work chamber 90. By connecting the breeding section 20 and the working chamber 90, the first piping 202 guides fish in the breeding section 20 from the breeding section 20 to the working chamber 90. For example, the water pressure when the liquid LQ moves from the growing section 20 to the working chamber 90 is used to guide the fishes from the growing section 20 to the working chamber 90.

The first piping 202 has a lid 207. The lid 207 opens and closes the first piping 202. When the lid 207 opens the first piping 202, the first piping 202 is connected to the growing section 20 and the working chamber 90. When the lid 207 closes the first piping 202, the growing section 20 and the working chamber 90 become non-connected.

The second piping 203 guides the feed to the growing section 20. One end of the second pipe 203 is located above ground. The other end of the second pipe 203 is located inside the growing section 20. When feeding the fish in the growing section 20, feed is inserted from one end of the second piping 203. The feed is then guided to the other end. Furthermore, the feed is released from the other end of the second pipe 203 into the interior of the growing section 20. Therefore, fish in the growing section 20 of the underground G2 can be fed from the ground. As a result, it is possible to reduce the time and effort required for workers to go to the growing section 20 in the ground G2 to feed the fish.

The third pipe 204 guides oxygen to the growing section 20.

The fifth pipe 205 connects the ground surface G1 to the growing section 20. The fifth pipe 205 is a communication path between the ground and the growing section 20. For example, an operator can reach the interior of the growing section 20 through the fifth pipe 205.

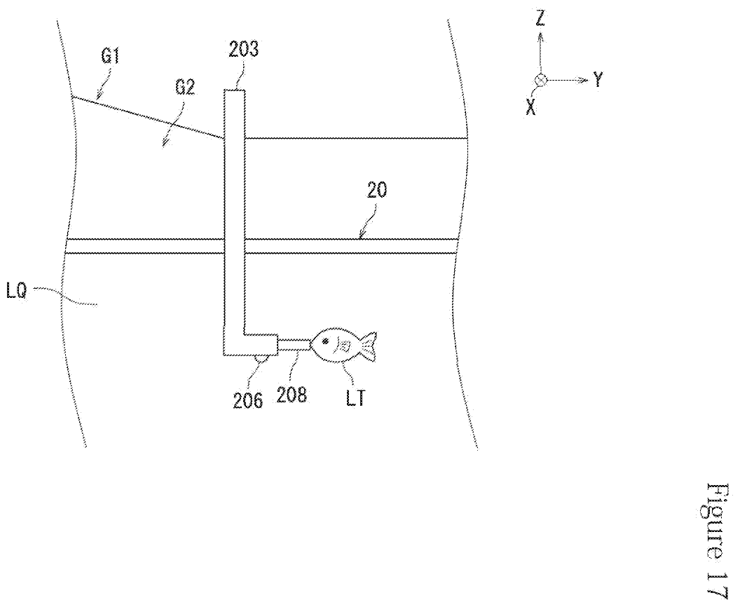

Next, the second piping 203 will be described in more detail with reference to FIG. 17. FIG. 17 shows the second piping 203 of the heat insulation system 1 according to embodiment 5.

The end portion of the second piping 203, located inside the growing section 20, is curved. The end portion of the second piping 203 has a feed port 208. The feeding port 208 discharges feed into the interior of the growing section 20.

The outer surface of the feed opening 208 has a rasp portion. By having the rasp portion on the outer surface of the feeding mouth 208, the teeth of the fish can be sharpened. As a result, the fish being raised can be prevented from injuring other fish. For example, when a plurality of fishes with continuously growing teeth are grown in the growing section 20, the fishes may bite other fishes. However, by placing a rasp portion on the outer surface of the feeding mouth 208, the teeth of the fishes come in contact with the rasp portion during feeding, and the teeth of the fishes are scraped. Therefore, when the teeth of the fish come into contact with other fish, they are less likely to damage the fish. As a result, a plurality of fishes can be grown efficiently while preventing fishes from injuring other fishes.

The growing section 20 further has a light source 206. The light source 206 emits light. The light source 206 is fixed to the second piping 203. The light source 206 illuminates the feeding port 208. As the light source 206 illuminates the feed opening 208, the fish can recognize the feed coming out of the opening 208. As a result, feeding of fishes can be facilitated. The growing section 20 may be disposed in a space located in the ground G2.

### Form 6.

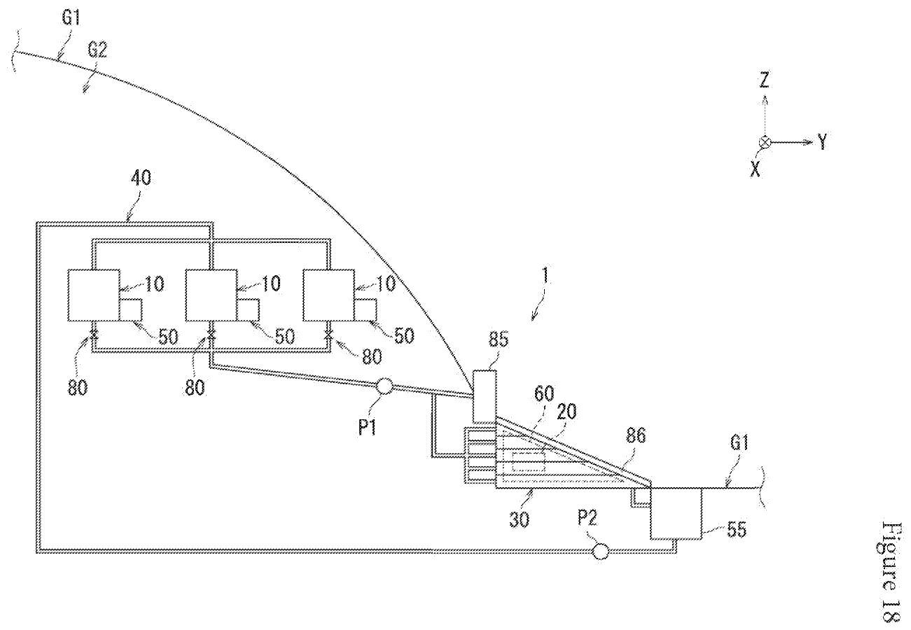

Next, referring to FIG. 18, the heat retention system 1 of embodiment 6 will be described. The heat-retention system 1 of embodiment 6 differs from the heat-retention system 1 of embodiment 1 to embodiment 5 in that it has a water-sprinkling section 85. The following describes the matters of embodiment 6 that differ from those of embodiments 1 to 5, and omits explanations of parts that overlap with those of embodiments 1 to 5.

FIG. 18 schematically shows the heat retention system 1 of embodiment 6 of the present invention. The heat retention system 1 of embodiment 6 has a plurality of storage sections 10, a growing section 20, a tube section 30, a guide section 40, a temperature control section 50, a storage section 55, a housing section 60, a switching section 80, a watering section 85, a sheet 86, a first pump P1, and a second pump P2.

Each of the plurality of storage sections 10 stores liquid LQ. The growing section 20 grows organisms LF. The cylinder 30 constitutes a flow path for the liquid LQ. The guide section 40 guides the liquid LQ stored in the storage section 10 to the cylinder section 30. The temperature control section 50 adjusts the temperature of the liquid LQ stored in the storage section 10. The storage section 55 stores the liquid LQ that flows out from the plurality of cylinder sections 30. The storage section 60 houses the growing section 20.

The switching section 80 switches the source of the liquid LQ that is guided toward the plurality of cylindrical sections 30. The switching section 80 also switches the source of supply of the liquid LQ that is guided toward the water sprinkler section 85.

The first pump P1 transfers the liquid LQ flowing out of the storage section 10 toward the plurality of cylinders 30. The second pump P2 transfers the liquid LQ flowing out of the storage section 55 toward the storage section 10.

The shape of the storage section 60 of the heat retention system 1 of embodiment 6 is a short triangle in cross-sectional view. The housing section 60 is inclined in the direction from the storage section 10 to the storage section 55. The ceiling portion of the storage section 60 is open.

The sheet 86 covers the ceiling of the housing section 60. The sheet 86 is impermeable to water.

The sprinkler section 85 sprays liquid LQ. The sprinkler system is a sprinkler system. The sprinkler is located at the ground surface G1. The sprinkler sprays the liquid LQ toward the sheet 86 at the ground surface G1. The liquid LQ sprayed by the sprinkler 85 vaporizes. Therefore, the temperature near the containment area 60 can be adjusted by vaporizing the liquid LQ. As a result, the temperature of the housing section 60 can be adjusted by adjusting the temperature near the housing section 60.

The embodiments of the present invention have been described above with reference to the drawings. However, the present invention is not limited to the above embodiments, and can be implemented in various ways without departing from the gist thereof. In addition, various inventions can be formed by combining the plural components disclosed in the above embodiments as appropriate. For example, some components may be deleted from all components shown in the embodiments. Furthermore, components across different embodiments may be combined as appropriate. The drawings show each component mainly schematically for case of understanding, and the thickness, length, number, spacing, etc. of each component shown in the drawings may differ from the actual situation due to drawing convenience. In addition, the speed, material, shape, dimensions, etc. of each component shown in the above embodiments are examples and are not particularly limited, and various changes can be made to the extent that they do not substantially deviate from the configuration of the present invention.

(1) In the heat retention system 1 of Embodiment 1, one housing section 60 is described as an example. The heat retention system 1 may have a plurality of housing sections 60.

(2) In the heat insulation system 1 of Embodiment 1, the moving portion 70 has a straight portion 731, a curved portion 732, and a course changing portion 733. The moving section 70 may have only a straight section 731.

(3) The switching section 80 of the embodiment 1 had the first valve disc 81A to the third valve disc 81C, but this is not limited thereto. For example, the switching section 80 may have the second valve disc A, the second valve disc B, and the second valve disc C.

The second valve plug A opens and closes the inlet of the first storage section 10A. When the second valve plug A opens the inlet of the first storage section 10A, liquid LQ flows from the ninth guiding section 49A into the first storage section 10A. In other words, the liquid LQ is stored in the first reservoir 10A. When the second valve plug A closes the inlet of the first storage section 10A, it prevents liquid LQ from flowing from the ninth guiding section 49A into the first storage section 10A.

The second valve plug B opens and closes the inlet of the second storage section 10B. When the second valve plug B opens the inlet of the second storage section 10B, liquid LQ flows into the second storage section 10B from the ninth guide section 49B. In other words, the liquid LQ is stored in the second storage section 10B. When the second valve plug B closes the inlet of the second storage section 10B, it prevents liquid LQ from flowing from the ninth guiding section 49B into the second storage section 10B.

The second valve plug C opens and closes the inlet of the third storage section 10C. When the second valve plug C opens the inlet of the third storage section 10C, liquid LQ flows into the third storage section 10C from the ninth guide section 49C. In other words, the liquid LQ is stored in the third storage section 10C. By blocking the inlet of the third storage section 10C, the second valve plug C prevents liquid LQ from flowing from the ninth guiding section 49C into the third storage section 10C.

(4) The heat insulation system 1 of embodiment 6 may further comprise a passageway 35 and a workroom 90.

(5) The present application further discloses the following additions. The following additions do not limit the invention.

### (Appendix)

The temperature of the growing section 20 is adjusted by the liquid LQ in the storage section 10 located in the ground G2. The temperature of the liquid LQ stored in the storage section 10 located in the ground G2 varies depending on its position from the ground surface G1. The temperature of the liquid LQ in the reservoir 10 located in the ground G2 is stable. Therefore, the temperature of the growing section 20 can be adjusted using the ground temperature. As a result, the cost of raising organisms LF can be controlled. In other words, the cost of heating and cooling the growing section 20 can be controlled. The heat retention system 1 can be used for sustainable industry.

For example, if the organism LF is an insect, the cycle of hibernation, growth, and egg laying can be established by adjusting the temperature of the growing section 20. For example, the liquid LQ stored in the storage section 10, which is located 5 meters from the ground surface G1, has a temperature of about 15 degrees Celsius throughout the year. Therefore, it can be used for cooling the growing section 20 during the summer.

When heating the growing section 20, warmed liquid LQ may be flowed into the guiding section 40. When cooling the growing section 20, a cooling substance may be simultaneously flowed into the guiding section 40.

The moving section 70 can move the growing section 20. Therefore, the worker does not have to go around the growing section 20 for the organisms grown in the growing section 20. The loading section 71, on which the growing section 20 is placed, is guided to the working room 90. Therefore, the worker can work in a large space such as the workroom 90. Also, after the work, the growing section 20 can be moved into the interior of the housing section 60 by the moving section 70. For example, when harvesting insects, the growing section 20, in which insects are grown, is moved to the working room 90.

The size of the housing section 60 is suitable for growing the organism LF to be grown. The size of the housing section 60 may be large enough for a worker to move on the loading section 71 for maintenance and inspection.

The switching unit 80 switches the source of supply of liquid LQ. Thus, the growing section 20 can be cooled in the summer and heated in the winter. As a result, the growth of organisms LF can be controlled. For example, insects can be raised year-round.

Microorganisms may also be grown in the reservoir 10. The microorganism is, for example, aurantiochytrium. In addition, algae may be grown in the storage section 10. The algae is, for example, enomotozoa. The heat retention system 1 may further comprise a guiding section 40 for guiding the algae if the guiding section 40 guides the algae along with the liquid LQ.

The heat source of the temperature control section 50, which adjusts the temperature of the storage section 10, may be hot water gushing out of the ground G2. The temperature control section 50 may also heat the liquid LQ in the storage section 10 by burning wood.

The main body of the housing 60A is closed off by the lid 60B. Therefore, the inner space of the housing section 60 is shut off from the outside world. Therefore, if the organism LF is a plant, crossbreeding can be prevented.

The cylindrical part 30 is laid on the ground. The cylinder is made from recycled plastic bottles. The sheet is located between the tube and the ground surface G1. The four sides of the growing section 20 are covered with the tube section 30. The growing sections 20 are arranged in a row. A number of growing sections are connected in a chain, like a train.

A temperature control unit may be located in the workroom 90.

The 10 underground G2 reservoirs may be pre-stored with groundwater. The storage section 10 of the underground G2 may also store rainwater.

The liquid LQ stored in the storage section 10 is allowed to flow into the cylinder section 30, which is composed of an object such as a plastic bottle, in appropriate quantities by the first pump P1. The liquid LQ that flows out of the cylinder section 30 is then collected in the storage section 55 or 56.

The cylinder is transparent. Since the cylinder is transparent, even if liquid LQ is placed inside the cylinder, the cylinder will transmit sunlight. This means that the cylindrical section 30 can be arranged in multiple layers.

The height of the storage section 10 and the cylinder section 30 may be different. The liquid guided by the guide section 40 flows from the storage section 10 to the cylinder section 30 by gravity. Therefore, the output of the first pump P1 can be reduced.

The cylinder section 30 has a plurality of cylinders 31. The plurality of cylindrical bodies 31 are connected vertically. In other words, if the cylindrical bodies 31 like PET bottles are connected vertically, there will be a plurality of entrances for liquid LQ. However, since the number of flow paths through which liquid LQ flows increases, the efficiency of adjusting the temperature of the growing section 20 is improved. A member with high heat storage properties may be placed in the cylinder 31, such as a plastic bottle. For example, the member with high heat storage properties is a rock. For example, the temperature of the liquid LQ is adjusted when the liquid LQ passes through the cylinder 31 in which the heat-storing rock is placed.

You may also grow living organisms LF, such as fish, inside the tube section 30.

A cushioning member may be placed between the cylindrical portions 30 and 30. The cushioning material is, for example, polystyrene containing air bubbles. For example, it can suppress the contact between the cylindrical part and the cylindrical part 30 during an earthquake.

The shape of the cylindrical section 30 may be changed. Since the plurality of cylindrical sections 30 consists of a plurality of cylindrical bodies 31, recombination is easy. Therefore, the best combination can be selected considering the installation cost and durability of the cylindrical sections 30. For example, the ceiling portion of the housing section 60 may not be covered by the cylinder section 30. For example, the top or sides of the housing section 60 may be covered with a sheet 86. The sheet 86 is, for example, a water-resistant vinyl. The sheet 86 may be sloped and attached to the tube section 30 so that the liquid LQ flows over the sheet 86. A plurality of sheets 86 may be stacked on top of each other and the liquid LQ may be sprayed in a mist between the sheets 86.

In order to make the temperature of the growing section 20 the desired temperature, the amount of liquid LQ flowing into the cylinder 30 may be changed. The cylinder 31 can be a cylindrical structure.

The sheet 86 does not have to transmit sunlight. If it is not necessary to transmit sunlight, a light-shielding member that does not transmit light may be attached to the cylinder 30. The light-shielding member covers the cylinder 30. The liquid LQ may also be colored. For example, the liquid LQ may be colored black.

Plants are grown in the ground G2. For example, the temperature at a location 5 m from the ground surface G1 is between 15 and 17 degrees Celsius throughout the year. In other words, when the housing 60 is placed at 5 m from the ground surface G1, the organism LF can be grown at a stable temperature.

The size of the housing section 60 is about the same as the size of the plants to be grown in the growing section 20 when they are harvested. As a result, the temperature of the housing section 60 can be easily adjusted without having to adjust the temperature of unnecessary spaces.

The housing section 60 is opened and closed by the lid 60B. For example, when the lid 60B is closed, the plants are shut off from the outside world. Therefore, it is possible to prevent pests and viruses from attaching to the plants. As a result, plants can be easily managed.

By opening the lid 60B, the temperature of the housing section 60 can be lowered. When lowering the temperature of the housing section 60, the air of the working room 90 may be sent from the working room 90 to the housing section 60.

The inner surface 61 of the housing 60 may be covered with a reflective member 65. The reflective member 65 is, for example, aluminum. The reflective member 65 can be a material that reflects light. By covering the inner surface 61 of the housing section 60 with the reflective member 65, the reflective member 65 can reflect light back to the growing section 20. As a result, the plants can photosynthesize efficiently.

The light emitted from the light-emitting part 63 is used for photosynthesis by plants. Specifically, the light necessary for photosynthesis in plants is collected from sunlight and transmitted to the growing section 20 via an optical fiber. The light required for photosynthesis in plants is also transmitted from the thermal radiation light source to the growing section 20 via an optical fiber. The thermal radiation light source converts thermal energy into visible light and electromagnetic waves of wavelengths useful for plant growth. As a result, the costs incurred in growing plants can be controlled. The light-emitting portion 63 is positioned to correspond to the growing portion 20 contained in the housing portion 60. Specifically, the light-emitting portion 63 is positioned in the housing portion 60 so that the light reaches the growing portion 20 equally.

When sunlight is weak, the light from the thermal radiation member 95 can be guided to the light emitting part 63. The thermal radiation component 95 can convert thermal energy into visible light and electromagnetic waves of frequencies useful for plant growth. The light can then be guided to the light-emitting part 63.

The introduction section 92 introduces heated air and carbon dioxide contained in the heated air into the housing section 60. Therefore, the housing section 60 can be heated. In addition, since the housing section 60 insulated by the heat insulating member 64 is heated, it can be heated efficiently. Furthermore, since carbon dioxide is introduced into the housing section 60, the placement of carbon dioxide in the air can be suppressed. In other words, plants can be grown while suppressing the emission of carbon dioxide into the air.

The growing section 20 is placed on the placing section 71 of the moving section 70. The loading section 71 is connected to the placing section 71 by the connecting section 75. For example, when harvesting the plants grown in the growing section 20, the drive unit 76 disposed on the second direction A2 side of the housing section 60 pulls the placing section 71 to the working room 90. Then, the loading section 71 carrying the growing section 20 moves to the working room 90. When the plants grown in the growing section 20 are moved into the housing section 60, the drive unit 76 arranged on the first direction A1 side of the housing section 60 pulls the placing section 71 from the working room 90 to the inside of the housing section 60. In addition, when checking the growing status of plants, the drive unit 76 also moves the loading section 71 on which the growing section 20 is placed. Therefore, the operator does not have to move inside the housing section 60 when planting plants, checking plants, and harvesting plants. As a result, the burden on the operator when working on the plants can be reduced.

The storage section 10 stores liquid LQ. The liquid LQ contains fertilizer. The guide section 40 guides the liquid LQ containing the fertilizer to the growing section 20. As a result, fertilizer can be easily supplied to the growing section 20 contained in the housing section 60. In addition, by inclining the housing section 60 and allowing the liquid LQ to flow in, the liquid LQ flows from above the inclination to below, allowing the housing section 60 to be cleaned.

The heat retention system 1 is preferably placed in a mountainous area. For example, the wood in the mountainous area can be heated by the heating unit 91. In other words, when the heat retention system 1 is placed in a mountainous area, the wood in the mountainous area can be used as a source of heat energy for the thermal radiation light source. The heating section 91 may also include a biomass generator. The trees, which are the wood to be used as fuel, may be planted and grown in the mountainous area. When planting trees that are wood to be used as fuel, the distance between trees is narrowed and the trees are planted. In addition, the planting and felling of trees can be repeated to secure wood.

In addition, when the heat insulation system 1 is placed in a mountainous area, wood from nearby areas can be used, thus reducing the cost of transporting wood.

In addition, the heat retention system 1 can introduce carbon dioxide generated when the heating section 91 heats the wood and the wood burns into the housing section 60. Plants use carbon dioxide during photosynthesis. By introducing carbon dioxide into the housing 60, the growth of plants can be promoted. By introducing carbon dioxide into the housing 60, the yield of the plants can be increased by 25% to 30% compared to the case where no carbon dioxide is introduced into the housing 60. Also, since carbon dioxide is introduced into the housing 60 along with heated air, the housing 60 is heated.

By placing the heat retention system 1 in mountainous areas, the forestry industry in mountainous areas can be revitalized. In other words, depopulated mountainous areas can become self-sustaining as an industry. In addition, the revitalization of the forestry industry will enable the management of abandoned forests. As a result, we will be able to take advantage of the inherent global warming prevention effects of forests.

According to the heat retention system 1, forests can be preserved while reducing the installation cost. Furthermore, the heat retention system 1 can also grow plants. The heat retention system 1 can also improve the production efficiency of plants while reducing the cost of plant cultivation. In addition, the heat retention system 1 can efficiently produce crops while preserving the environment by using the natural circulation cycle.

According to the heat retention system 1, there is no need to arrange air conditioning facilities to maintain the temperature necessary for crop growth. In other words, there is no need for fossil fuels or large power generation facilities.

According to the heat retention system 1, the cost of installing a plastic greenhouse and securing a work space can be reduced when securing a cultivation space.

According to the heat retention system 1, the cost of maintaining the temperature of the housing section 60 can be controlled.

According to the heat retention system 1, the cost of installing the growing section 20 above ground can be reduced.

According to the heat retention system 1, insects and insect food plants may be grown simultaneously in the growing section 20 contained in the housing section 60.

According to the heat retention system 1, and also by arranging a plurality of housing sections 60 in the ground G2, the amount of harvest can be increased compared to the case of growing plants above ground.

According to the heat retention system 1, the cost incurred in growing fish can be controlled. Specifically, for example, the growing section 20, which is an aquaculture space, is arranged at a position that is “5 meters” from the ground surface G1. For example, in Honshu, Japan, the temperature of the growing area 20 is maintained at “15 to 17 degrees Celsius or higher” throughout the year by locating the growing area 20 at “5 meters” from the ground surface G1. Since there is a difference depending on the latitude, the position of the growing section 20 may be changed according to the latitude. The water temperature of the growing section 20 can be adjusted by using the fact that the temperature of the growing section 20 is maintained at 15 to 17 degrees or higher throughout the year. The liquid LQ in the growing section 20 may be described as breeding water. The breeding water can be fresh water or seawater. As a result, fish can be raised in the growing section 20, which is an underground aquaculture space, while controlling the cost of adjusting the temperature of the growing section 20.

Also, since the growing section 20 can be placed in the ground G2, the size of the growing section 20 can be freely selected compared to the case where the growing section 20 is placed on the ground. For example, compared to the case of arranging the growing section 20 on the ground, a larger growing section 20 can be arranged in the ground G2, allowing fish to be raised in the growing section 20 at an appropriate density. In other words, fish can be raised in such a way that fish are not overcrowded relative to the capacity of the growing section 20. Therefore, the density of fish can be changed according to the size of the growing section 20. As a result, it is possible to reduce the stress felt by the fish being raised. For example, the stress can prevent the fish from biting each other.

Feeding of fish being grown in the growing section 20 in the ground G2 is done through the second piping 203. The feed is fed into the second piping 203. The feed for the fish being grown in the growing section 20 is viscous. The feed is a kneaded feed. When the feed is guided from the second piping 203 to the growing section 20, the feed is sent to the growing section 20 so that the feed comes out of the feeding port 208 little by little. As the feed comes out of the feed opening 208, the teeth of the fish come in contact with the rasp portion of the outer surface of the feed opening 208 when the fish eat the feed. As a result, the teeth of the fish are worn down. As a result, the time and effort required to cut the teeth of the fish can be reduced. Since the light source 206 is disposed in the second piping 203, the fishes to be grown in the growing section 20 can be collected.

A further passage may be provided for workers to descend to the growing section 20, which is an underground aquaculture space. The growing section 20 may also have an image capturing unit. The image capturing unit is, for example, a camera. The image capturing unit captures images of the fishes. The image capturing unit takes images of the fishes and generates images or videos. The image capturing unit can monitor the growth status of the fishes. When a display unit is placed in the workroom 90, the image or video generated by the imaging capturing unit is displayed on the display unit. This means that the operator can remotely check the growth status of the fishes. When the grown fishes are taken out of the working room 90, they are transported together with the breeding water by using water pressure.

In the heat retention system 1, the storage section 10 is placed at the highest position to take advantage of the height difference. Then, the growing section 20 is placed below the storage section 10. Furthermore, the workroom 90 is located below the growing section 20. A storage section for storing the liquid LQ flowing out of the growing section 20 may be further arranged below the growing section 20. The third piping 204, which shares oxygen to the growing section 20, is extended from the ground surface G1 to the growing section 20 in the ground G2.

In the heat retention system 1, the plurality of storage sections 10 have different depths from the ground surface G1. In other words, the temperature of the liquid LQ stored in each of the plurality of reservoirs 10 is different. Therefore, the plurality of reservoirs 10 storing liquid LQ of different temperatures from each other can be used to maintain the temperature necessary for the growth of fish. In general, the temperature of the liquid LQ stored in the storage section 10 located at the deepest position is higher. This means that the water temperature can be easily adjusted by moving the liquid LQ stored in the storage section 10 located at the deepest position to the growth section 20.

You may also grow organisms LF on the ground. The organisms LF to be grown on the ground are, for example, insects. The organism to be grown on the ground is the food for the organism to be grown in the growing section 20. As a result, the cost of feed for the organisms can be reduced. In addition, abandoned farmland can be used to grow grass that can be used as food for insects. The cultivation of organisms LF and the use of abandoned farmland can lead to the revitalization of the region.

There may be a plurality of guiding sections 40 that guide the liquid LQ to the filtration section F. For example, if the growing section 20 is rectangular, the guiding sections 40 that guide the liquid LQ to the filtration section F are placed at the corners of the growing section 20. Therefore, fish excrement and waste accumulated in the corners of the growing section 20 can be guided to the filtration section F. Therefore, the water quality of the growing section 20 can be maintained. The filtration section F may also have a liquid reuse section. The liquid reuse section performs a process to reuse the liquid I.Q.

It may also have a reinforcing member. The reinforcing member reinforces the growing section 20, the tube section 30, and the housing section 60. The reinforcing member may be a sheet and an adhesive material. The reinforcing member may be placed in the working chamber 90.

When hydroponic cultivation is performed in the growing section 20, the growing section 20 may further have a plant holding section. The plant holding part is, for example, rock wool and a sponge. The plants are placed in the rock wool. The rock wool can be removed from the growing section 20. The plant holding section can be placed on the moving section 70 and moved.

### INDUSTRIAL APPLICABILITY

The present invention can be used in the field of heat retention systems and devices.

### EXPLANATION OF THE CODE

1 Heat insulation system
10 Reservoir
10A First storage section
10B Second storage section
10C Third storage section
20 Growing section (first housing section)
30 Cylinder section (flow channel section)
31 Cylinder (channel body)
40 Guide section
60 Storage section (second storage section)
63 Light-emitting part
64 Thermal insulation materials
65 Reflective components
70 Moving part
80 Switching section
90 Workroom
92 Introduction
95 Thermal radiation components
96 Second light guide section (light guide section)
G1 Ground surface
G2 Underground

What is claimed is:

1. A passage part that constitutes a passage for a substance as a medium for transporting heat-comprising:
A storage unit for storing the substance;
A guide section that connects the storage section to the passage section and guides the substance from the storage section to the passage section;
and
The passageway section is located in a containment space that houses an object, a heat retention system.

2. The heat retention system as claimed in claim 1, wherein the passage section is located outside the first housing section.

3. The heat retention system as claimed in claim 2, wherein the guiding section guides the liquid from the storage section to the passage section.

4. The heat retention system as claimed in claim 3, wherein the passageway section is located along the outer surface of the second housing section.

5. The heat retention system according to claim 4, wherein the second housing area is located underground.

6. The heat retention system according to claim 3, further comprising a moving unit to move the first housing unit.

7. The heat retention system according to claim 3, wherein the passage section transmits light.

8. A heat retention system as claimed in claim 3, wherein the plurality of passage bodies are connected in series.

9. The heat retention system according claim 3, wherein the switching section switches the source of supply from the storage section that is set as the source of supply among the plurality of storage sections to another storage section.

10. The heat retention system according to claim 1, wherein the workroom is shut off from the outside.

11. A passage part as claimed in claim 1 constitutes a passage for a substance as a medium for transporting heat.
A guide section that guides the substance stored in the storage section from the storage section to the passage section.
and
The passageway section is located in the housing space where the object is housed.

12. The heat retention device as claimed in claim 11, wherein the passage is located outside the first housing section.

13. The heat retention device as claimed in claim 12, wherein the guiding section guides the liquid from the storage section to the passage section.

14. A first housing section that houses an object.
A second housing section that houses the first housing section.
A thermal radiation member that emits light when heated.
A light guide part that guides the light emitted by the thermal radiation member.
and
The second housing section has a light-emitting part that emits light.
The light guide guides the light emitted by the thermal radiation member to the light emitting part.
The light emitting part fires light that is guided by the light guide, heat retention system.

15. The first housing area is used to grow organisms and
The heat retention system according to claim 14, wherein the second housing area is located underground.

16. A plurality of storage sections where the temperature of the stored material differs from each other.
A first housing section that houses an object.
A guide section that connects the storage section to the first compartment and guides the substance from the storage section to the first compartment.
A switching unit that switches the source of supply of the substance being guided to the first housing section.
and
The switching section switches the source of supply from the storage section set to be the source of supply among the plurality of storage sections to another storage section, the heat retention system.

17. A heat retention system as claimed in claim 16, wherein the switching unit switches the source of the liquid being guided to the first containment area.

18. The heat retention system of claim 17, wherein the size of the first containment area is based on the size of the organism.
